(19) United States
(12) Patent Application Publication
(10) Pub. No.: US 2014/0242220 A1
(43) Pub. Date: Aug. 28, 2014

(54) Microfluidization of Brans and Uses Thereof

(71) Applicants: Guibing Chen, Concord, NC (US); Julia Raddatz, Cornelius, NC (US); Tao Wang, Kannapolis, NC (US)

(72) Inventors: Guibing Chen, Concord, NC (US); Julia Raddatz, Cornelius, NC (US); Tao Wang, Kannapolis, NC (US)

(21) Appl. No.: 14/194,237

(22) Filed: Feb. 28, 2014

Related U.S. Application Data
(60) Provisional application No. 61/770,834, filed on Feb. 28, 2013.
(60) Provisional application No. 61/860,034, filed on Jul. 30, 2013.

(51) Int. Cl. A23L 1/308

(52) U.S. Cl. CPC A23L 1/3081
USPC 426/71; 426/629; 426/589; 426/590

(57) ABSTRACT

The present application generally relates to the development of palatable fiber-enriched foodstuffs, including but not limited to soups, salad dressings, dips, sauces, baked goods and beverages, through modifying various dietary fiber ingredients using a novel mechanical approach.

### RELATED APPLICATIONS

This application claims priority under 35 U.S.C. §119(e) to U.S. Provisional Patent Application Ser. No. 61/770,834 filed Feb. 28, 2013 and U.S. Provisional Patent Application Ser. No. 61/860,034, filed Aug. 9, 2013, the disclosure of each of which is incorporated herein by reference in its entirety.

### STATEMENT OF FEDERAL SUPPORT

This invention was made with government support under Federal Grant No. 2012-38821-20066 awarded by the National Institute of Food and Agriculture, United States Department of Agriculture. The government has certain rights to this invention.

### FIELD

The present inventions relate generally to the microfluidization of bran, to compositions containing microfluidized bran and to methods of preparation thereof.

### BACKGROUND

Dietary fiber is generally defined as the edible parts of plants or analogous carbohydrates that resist digestion and absorption in the human small intestine, with complete or partial fermentation in the human large intestine. Wheat, oat and corn brans are natural ingredients rich in dietary fiber, both water-insoluble and water-soluble fiber, as well as antioxidants. Wheat and corn brans are produced in large quantities in the United States with an annual production of 7.5 million tons and 0.341 million tons, respectively.

Although recognition of the role dietary fiber plays in diet continues to grow, national data consistently show that both children and adults consume less than one-half of the recommended daily intakes of dietary fiber.

One strategy to increase fiber consumption is to prepare foods that are supplemented with fiber-rich ingredients. However, formulating foods enriched in dietary fiber presents challenges since the addition of fiber-rich ingredients may adversely affect the color, texture, flavor and/or taste of the supplemented foods.

There is a need for compositions and methods for increasing the fiber content of foodstuffs and for improving the color, texture, flavor and taste of fiber-rich foodstuff. A solution is needed to improve sensory properties of foods containing high levels of fiber ingredients and to enhance the nutritional value of foodstuffs.

The present application discloses using microfluidized brans having improved physicochemical and nutritional properties, as well as improved sensory attributes (e.g. taste, texture, and/or smell), compared to untreated brans. These improved properties extend to foodstuffs containing microfluidized brans.

### SUMMARY OF THE CLAIMED INVENTION

As disclosed herein, microfluidization has been employed to efficiently and effectively modify brans, including but not limited to wheat bran, corn bran, oat bran, rice bran, barley bran, rye bran, and millet bran. The palatability and nutritional value of foods supplemented with microfluidized brans as disclosed herein may be improved. Having more palatable, fiber-enriched food options can promote the intake of dietary fiber.

In some embodiments, the present invention provides microfluidized bran, as well as methods of making and using microfluidized bran. In some embodiments, the microfluidized bran disclosed herein has an average particle size of about 150 μm or less, or between about 50 μm and about 150 μm. In one variation, at least about 50% of the total particle volume comprises particles having a diameter of less than about 100 μm.

In some embodiments, the present invention provides foodstuffs comprising microfluidized bran. In some embodiments, the microfluidized bran comprises oat bran, wheat bran, corn bran, rice bran, rye bran, barley bran and/or millet bran. In some embodiments, the microfluidized bran comprises oat bran, corn bran, rice bran, rye bran, barley bran and/or millet bran.

In some embodiments, the foodstuff is a flour mixture. In some embodiments, the foodstuff is a soup, salad dressing, dip, sauce, backed good, extruded cereal or beverage. In some embodiments, the foodstuff is a baked good, optionally bread, or a beverage, optionally milk.

In some embodiments, the present invention provides methods of producing foodstuffs having increased fiber content. Such methods may comprise, consist essentially of or consist of adding microfluidized bran to a foodstuff. In some embodiments, the methods comprise, consist essentially of or consist of microfluidizing bran, collecting the microfluidized bran, optionally via filtration (e.g., vacuum filtration), and adding the resulting wet microfluidized bran to a foodstuff. In some embodiments, the microfluidized bran is dried before incorporating the microfluidized bran into the foodstuff.

These and other objects and aspects of the present invention are explained in detail in the drawings and specification set forth below and will become apparent to those skilled in the art after a reading of the following description of the disclosure when considered with the drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 shows a typical particle size distribution of ground wheat bran particles before and after microfluidization in accordance with some embodiments of the present invention.

FIG. 2 shows selected properties of ground wheat raw bran and wheat bran samples treated with 1, 2, and 3 passes through the microfluidizer as disclosed herein in accordance with some embodiments of the present invention.

FIG. 3 shows a typical particle size distribution corn bran particles before and after microfluidization in accordance with some embodiments of the present invention.

FIG. 4 shows the effects of interaction chamber size and number of passes through a microfluidizer on the bulk density of wheat bran. Values are means±S.D. (n=2, a=3). Different letters above the bars indicate significant differences between the groups (P<0.05).

FIG. 5 shows the effects of interaction chamber size and number of passes through a microfluidizer on the water-holding capacity (WHC) and swelling capacity (SC) of wheat bran. Values are means±S.D. (n=2, a=3).

FIG. 6 shows the effects of interaction chamber size and number of passes through a microfluidizer on the oil-holding capacity (OHC) of wheat bran. Values are means±S.D. (n=2, a=3). Different letters above the bars indicate significant differences between the groups (P<0.05).

FIG. 7 shows the effects of interaction chamber size and number of passes through a microfluidizer on the cation-exchange capacities (CEC) of wheat bran. Values are means±S.D. (n=2, a=3). Different letters above the bars indicate significant differences between the groups (P<0.05).

FIG. 8 shows the effects of interaction chamber size and number of passes through a microfluidizer on the surface-reactive phenolic contents of wheat bran (without alkali or acid hydrolysis). Values are means±S.D. (n=2, a=3). Different letters above the bars indicate significant differences between the groups (P<0.05).

FIG. 9 shows the effects of the interaction chamber size and the number of passes through a microfluidizer on the antioxidant activity of microfluidized wheat bran (without alkali or acid hydrolysis). (a) Trolox equivalent antioxidant capacity (TEAC); (b) DPPH radical scavenging activity; (c) reducing power; and (d) ferrous ion-chelating activity. Values are means±S.D. (n=2, a=3). Different letters above the bars indicate significant differences between the groups (P<0.05).

FIG. 10 shows the effect of microfluidization in accordance with some embodiments of the present invention on the bulk density of corn bran. Values are means±S.D. (n=2, a=3).

FIG. 11 shows the effect of microfluidization in accordance with some embodiments of the present invention on the swelling capacity (SC), water-holding capacity (WHC) and oil-holding capacity (OHC) of corn bran. Values are means±S. D. (n=2, a=3).

FIG. 12 shows the effect of microfluidization on the cation-exchange capacities (CEC) of corn bran. Values are means±S. D. (n=3, a=3).

It will be understood that the drawings are for the purpose of describing certain embodiments of the inventions and are not intended to limit the inventions thereto.

### DETAILED DESCRIPTION

The foregoing and other aspects of the present invention will now be described in more detail with respect to compositions and methodologies provided herein.

This description is not intended to be a detailed catalogue of all the ways in which the present invention may be implemented or of all the features that may be added to the present invention. For example, features illustrated with respect to one embodiment may be incorporated into other embodiments, and features illustrated with respect to a particular embodiment may be deleted from that embodiment. Thus, one or more of the method steps included in a particular method described herein may, in other embodiments, be omitted and/or performed independently. In addition, numerous variations and additions to the embodiments suggested herein, which do not depart from the instant invention, will be apparent to those skilled in the art in light of the instant disclosure. Hence, the following description is intended to illustrate some particular embodiments of the invention, and not to exhaustively specify all permutations, combinations and variations thereof. It should therefore be appreciated that the present invention is not limited to the particular embodiments set forth herein. Rather, these particular embodiments are provided sot hat this disclosure will more clearly convey the full scope of the invention to those skilled in the art.

The terminology used herein is for the purpose of describing particular embodiments of the present invention only and is not intended to limit the present invention. Although the following terms are believed to be well understood by one of skill in the art, the following definitions are set forth to facilitate understanding of the presently disclosed subject matter.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent techniques that would be apparent to one of skill in the art.

As used herein, the terms “a” or “an” or “the” may refer to one or more than one. For example, “a” surface can mean one surface or a plurality of surfaces.

As used herein, the term “about,” when used in reference to a measurable value such as an amount of mass, dose, time, temperature, and the like, is meant to encompass variations of +/−20% of the specified amount. All ranges set forth, unless otherwise stated, include the stated endpoints and all increments between.

As used herein, the term “and/or” refers to and encompasses any and all possible combinations of one or more of the associated listed items, as well as the lack of combinations when interpreted in the alternative (“or”).

As used herein, the term “bran” refers to the hard outer layers of a cereal grain. The outer layers of a cereal grain generally comprise at least the aleurone and the pericarp.

Bran is typically comprised of three major layers known as the outer pericarp, inner aleurone, and between them is a thin suberized membrane known as testa or seed coat. The pericarp can be further differentiated into a single-layered outer epicarp and several layers of thick-walled, pitted mesocarp, with one or more layers of cross and tube cells adjacent to the seed coat. The aleurone layer is characterized by relatively large, polygonal or quadrangular cells that form a regular network with thick wall.

In particular, corn bran is comprised of pericarp, testa, aleurone layer and a small amount of residual endosperm. The pericarp can be further subdivided into outer epicarp, a thick-walled fiber layer covered with wax-like cutin, mesocarp, consisting of multilayer of closely packed, hollow, elongated cells with numerous pits, a spongy layer of cross and tube cells. The innermost layer is a very thin suberized semipermeable membrane known as testa or seed coat. Surrounding the starchy endosperm cells, the aleurone layer in most corn varieties consists of a single layer of quadrangular or rectangular cells which forms a regular network with thick walls. In spite of the large size of corn endosperm compared with the other grains, individual aleurone cells are small, making up only 2% or less of the total weight of the kernel.

As used herein, the terms “cereal” and “cereal grain” include, but are not limited to wheat, corn, oats, rice, barley, rye, and millet.

As used herein, the term “baked good” include, but is not limited to bread, biscuits, bagels, bread sticks, buns, cakes, muffins, cakes, rolls, English muffins, pizza crust, tortillas, pancakes, waffles, batter-based products, breaded products, cookies, soft pretzels, hard pretzels, and crackers.

As used herein, the term “foodstuff” includes any substance that may be used or prepared for use as food.

As used herein, the term “particle size” refers to the volume mean diameter, i.e., the diameter of a particle whose volume, if multiplied by the total number of particles, will equal the total volume of the sample.

As used herein the term “specific surface area” refers to the total surface area of a bran per unit of mass or bulk volume. It is typically defined by surface area divided by mass (m²/kg), or surface area divided by the volume (m²/cm³).

As used herein, “median diameter of volume distribution” means that about 50% of the total particle volume comprises particles having a diameter less than the identified diameter. For example, a median diameter of volume distribution of 100 μm indicates that about 50% of the total particle volume comprises particles having a diameter of less than 100 μm.

As used herein “flour mixture” is the combination of maize, rye, and/or wheat flour as is typically used in the preparation of baked goods. Generally, the flour mixture is based on wheat flour, which includes, but is not limited to, white flour, unbleached all-purpose flour, bread flour, self-rising flour, cake flour, gluten flour, whole wheat flour or unbleached flour. As disclosed herein, microfluidized bran of the present application can substitute for fixed amounts of the flour mixture. Typically, in accordance with one aspect of the present invention, the flour mixture is replaced by at least about 10% microfluidized bran by mass. Alternately, the flour mixture is replaced by at least about 15% microfluidized bran by mass or by at least about 20% or by at least about 25% or at least about 30% or by at least about 35% or by at least about 40% microfluidized bran by mass. Generally, a flour mixture containing microfluidized bran contains between about 5% and about 40% microfluidized bran by mass. Alternately, the flour mixture contains between about 10% and about 35% microfluidized bran or between about 15% and about 30% microfluidized bran or between about 10% and about 25% microfluidized bran by mass or between about 18% and about 26% microfluidized bran by mass. Typically, when two different microfluidized brans are added to a flour mixture, a larger overall amount of flour mixture can be substituted, compared to substitution with a single microfluidized bran. Similarly, when quality improvers, known in the art to improve the quality of foodstuffs containing flour mixtures, such as baked goods, are employed, additional quantities of the microfluidized brans can be incorporated into the flour mixtures. Such quality improvers include, but are not limited to hydrocolloids (e.g. arabic gum, guar gum, xanthan gum and methyl 2-hydroxyethyl cellulose) or enzymes (e.g. amylase, maltogenic alpha-amylases, glucose oxidase, lipase, lipoxygenase, xylanase, protease, asparginase).

Microfluidization is a process carried out in a microfluidizer processor. As the reciprocating intensifier pump moves through its pressure stroke, it drives the product stream through an interaction chamber. Within the chamber is a fixed-geometry micro-channel through which the product stream accelerates to high velocities, creating high shear stress, impact force and hydrodynamic cavitation. Generally, the interaction chamber of available microfluidizers range from about 50 μm to about 300 μm; although other size interaction chambers can be used in the processes described herein. The process causes size reduction and microstructure changes of the suspended bran particles. Without being bound by theory, it is believed that the changes expose more water binding sites (e.g. polar groups) and phenolic compounds, which were originally cross-linked or embedded in the fiber matrix, to the surrounding environment. The processing pressure for most of the power stroke of a microfluidizer is constant, leading to nearly uniform shear and cavitation fields, and thus high energy efficiency.

Generally when the operating conditions (including pressure and the number of passes, where ‘a pass’ means that the sample goes through the microfluidizer one time) are held constant, the average particle size obtained depends on the type of bran that is treated. For example, when corn bran is processed through a 200 μm interaction chamber (“IC₂₀₀” or “IC200”) at 159 MPa (23,000 psi), the average particle size obtained is typically 112 μm and 65 μm for one-pass and two-pass processing, respectively. For both corn and wheat bran, the average particle size after processing through a 200 μm interaction chamber at 159 MPa, is usually between 50 μm and 120 μm. When oat bran is processed through a 300 μm interaction chamber at about 55 MPa (8000 psi) for 1 pass, the resulting particle size of 80 μm is appropriate for preparing baked goods or as a base for soups. Microfluidizing oat bran through a 200 μm interaction chamber (IC200) at about 159 MPa for 2-3 passes yields particle sizes of 17 μm and 13 μm, respectively, appropriate for use in beverages, such as oat milk.

The particle size of microfluidized bran distribution is generally a narrow distribution around the identified average. Typically, at least about 90% of the particles are found at ±25% of the average particle size, or at least at ±20% of the average particle size, or at least at ±15% of the average particle size, or at least at ±10% of the average particle size, or at least at ±5% of the average particle size. Alternately, at least about 75% of the particles are found at ±25% of the average particle size, or at least at ±20% of the average particle size, or at least at ±15% of the average particle size, or at least at ±10% of the average particle size, or at least at ±5% of the average particle size. Typically, at least about 20% of the particle volume is found at ±25% of the mean particle size after one-pass microfluidization, at least about 30% of the particle volume is found at ±25% of the mean particle size after two-pass microfluidization.

In another alternative, the average particle size of microfluidized bran, including but not limited to brans of wheat, corn, oats, rice, barley, rye, and millet, is no more than about 150 μm, no more than about 140 μm, no more than about 130 μm, no more than about 120 μm, no more than about 110 μm, no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 10 μm or no more than about 5 μm. In another alternative, the average particle size of microfluidized corn bran is no more than about 120 μm, no more than about 110 μm, no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 10 μm or no more than about 5 μm. In another alternative, the average particle size of microfluidized oat bran is no more than about 120 μm, no more than about 110μm, no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 10 μm or no more than about 5 μm.

In some embodiments, the present application discloses microfluidized corn bran having one or more of the following properties: (a) a specific surface area of at least about 0.15 m²/cm³; and (b) a median diameter of volume distribution of at most about 100 μm. Alternately, the specific surface area is at least about 0.2 m²/cm³, at least about 0.3 m²/cm³, at least about 0.35 m²/cm³, at least about 0.4 m²/cm³ or at least about 0.45 m²/cm³ and the median diameter of volume distribution is at most about 90 μm, at most about 85 μm, at most about 75 μm, at most about 65 μm, at most about 50 μm, at most about 40 μm, at most about 30 μm, or at most about 20 μm. In some embodiments, about 50% of the total particle volume comprises particles having a diameter of less than about 100 μm, less than about 80 μm, less than about 50 μm, less than about 30 μm, less than about 20 μm or even less than about 15 μm. In some embodiments, microfluidized corn bran has a specific surface area of at least about 0.05 m²/cm³, at least about 0.1 m²/cm³, at least about 0.15 m²/cm³, at least about 0.2 m²/cm³, at least about 0.25 m²/cm³ or at least about 0.3 m²/cm³. In some variations of any of the disclosed embodiments, about 50% of the particle volume is comprised of particles having a diameter between about 5 μm and about 40 μm, or about 10% of the total particle volume is comprised of particles having a diameter between about 5 μm and about 15 μm, alternately, about 10% of the total particle volume is comprised of particles having a diameter between about 110 μm and about 350 μm. In other variations of any of the disclosed embodiments, 50% of the particle volume is comprised of particles having a diameter between about 10 μm and about 35 μm, or between about 15 μm and about 30 μm. In some variations, particles with a size between about 5 μm and about 110 μm account for about 90% of the total volume; alternately, about 90% of the total volume is comprised of particles with a size between about 10 μm and about 105 μm, or particles with a size between about 15 μm and about 100 μm, or particles with a size between about 20 μm and about 95 μm, or particles with a size between about 25 μm and about 90 μm account for 90% of the total volume. Alternately, the present application discloses microfluidized corn bran having the properties disclosed in Table 4-1.

Microfluidization processing adds value to brans. Dietary fibers contained in these brans have favorable low bloating and slow fermentation profiles, making them desirable ingredients in processed foods. Physical processing modified the brans' microstructure and improves the functional properties to produce dietary fiber ingredients with the nutritional and nutraceutical benefits of whole grain. Indeed, microfluidized brans generally exhibit twice the antioxidant activity of unprocessed or ground brans, particularly for corn bran.

The extent of changes to brans' physiochemical and nutritional properties generally can be correlated with microfluidization processing conditions. The processing variables as disclosed herein include varying the process pressure, such as between about 55 MPa (8,000 psi) and about 414 MPa (60,000 psi) or between about 55 MPa (8,000 psi) and about 276 MPa (40,000 psi), and varying the number of passes, such as between 1 and 5, for example, 1, 2, 3, 4 or 5. Alternately, the process pressure can range from about 55 MPa to about 152 MPa (22,000 psi), or from about 124 MPa (18,000 psi) to about 179 MPa (26,000 psi), or from about 152 MPa to about 179 MPa. In some variations, the bran is microfluidized in a combination of steps with successively smaller interaction chambers, for example processing with IC200 at 159 MPa for 1, 2, or 3 passes, followed by processing with IC87 at 172 MPa for 1, 2, or 3 passes. Analogously, a bran can be processed with IC300 for 1-2 passes, followed by processing with IC87 for 1-2 passes, followed by processing with IC50 for 1-3 passes.

Microfluidization is particularly beneficial to the flavor and smell of corn bran. Processing, as disclosed herein, reduces undesirable flavors and smells and reduces the particle size of the corn bran; generally microfluidized corn bran is practically undetectable when eaten as a component part of foodstuffs. As disclosed herein, microfluidized corn bran can replace at least about 40% (wt/wt) flour or at least about 20% (wt/wt) flour in foodstuffs, particularly in baked foodstuffs, such as bread. Alternatively, microfluidized corn bran can replace, according to the studies disclosed herein, at least about 40%, at least about 35%, at least about 30%, at least about 25%, at least about 20%, at least about 15%, at least about 10% or at least about 5% (wt/wt) flour in foodstuffs.

As disclosed herein, microfluidized brans have been integrated into foodstuffs like baked goods such as bread, individually or in combination at high concentrations, allowing the production of high quality fiber-enriched food, such as bread, which have correspondingly increased health benefits. As disclosed herein, quality bread has been prepared from each of:
(1) 20% microfluidized corn bran+10% microfluidized oat bran+70% white unbleached flour (about 13 g dietary fiber/100 g bread),
(2) 15% microfluidized corn bran+15% microfluidized oat bran+70% (about 11 g dietary fiber/100 g bread) white flour, and
(3) 20% microfluidized corn bran+80% white unbleached flour.

Additionally, quality bread has been prepared from each of:
(1) 18% microfluidized corn bran+8% microfluidized oat bran+74% white unbleached flour,
(2) 8% microfluidized corn bran+18% microfluidized oat bran+74% white flour,
(3) 18% microfluidized corn bran+825 white unbleached flour, and
(4) 18% microfluidized oat bran+82% white unbleached flour.

As disclosed herein, corn bran can be incorporated into baked goods and increase the fiber content of those goods. The baked goods can also contain microfluidized oat bran, either in addition to or in place of microfluidized corn bran. In another example, microfluidized wheat bran is incorporated into baked goods at a high level either alone or in combination with microfluidized oat bran and/or microfluidized corn bran. As another example, microfluidized rice bran can be incorporated into baked goods at a high level either alone or in combination with microfluidized oat bran and/or microfluidized corn bran. As another example, microfluidized rye bran can be incorporated into baked goods at a high level either alone or in combination with microfluidized oat bran and/or microfluidized corn bran. As another example, microfluidized barley bran can be incorporated into baked goods at a high level either alone or in combination with microfluidized oat bran and/or microfluidized corn bran. As a further example, microfluidized millet bran can be incorporated into baked goods at a high level either alone or in combination with microfluidized oat bran and/or microfluidized corn bran.

Microfluidized brans can improve the fiber content and quality of baked goods, such as bread, biscuits, bagels, bread sticks, buns, cakes, muffins, cakes, rolls, English muffins, pizza crust, tortillas, pancakes, waffles, batter-based products, breaded products, cookies, soft pretzels, hard pretzels, and crackers, as well as salad dressing, dips, soups and sauces. In addition, microfluidized brans, including oat bran, rice bran and wheat bran, in particular einkorn wheat, can contribute to beverages, such as milk and beverages containing milk, such as smoothies, milkshakes, lattes etc. Such milks can be flavored, such as with vanilla, chocolate or other flavorings.

The present invention provides microfluidized bran, as well as methods of making and using microfluidized bran. Generally, the microfluidized bran disclosed herein has an average particle size of about 150 μm or less, or between about 50 μm and about 150 μm. In one variation, the microfluidized bran has a median diameter of volume distribution of at most about 100 μm.

In some embodiments, the present invention provides a foodstuff comprising microfluidized bran. In one variation, the microfluidized bran comprises, consists essentially of or consists of oat bran, wheat bran, corn bran, rice bran, rye bran, barley bran and/or millet bran. In one variation, the microfluidized bran comprises, consists essentially of or consists of oat bran, corn bran, rice bran, rye bran, barley bran and/or millet bran. Alternately, the microfluidized bran comprises oat bran, corn bran, and/or rice bran or the microfluidized bran comprises, consists essentially of or consists of oat bran and/or corn bran. Alternately, the microfluidized bran is oat bran or the microfluidized bran is corn bran. In one variation, the foodstuff is a soup, salad dressing, dip, sauce, baked good, extruded cereal or beverage. In other variation, the foodstuff is a baked good or extruded cereal; in one embodiment, the microfluidized bran in the baked good or extruded cereal is corn bran optionally in combination with oat bran. In another variation, the foodstuff is a baked good or beverage; in one embodiment, the microfluidized bran in the baked good or beverage is oat bran.

In some embodiments, the present invention provides foodstuff comprising microfluidized bran, wherein the microfluidized bran comprises, consists essentially of or consists of corn bran. In one variation, the foodstuff is a baked good and the microfluidized corn bran has a specific surface area of at least about 0.15 m²/cm³; and/or a median diameter of volume distribution of at most about 100 μm. In one variation, the microfluidized bran comprises microfluidized oat bran.

In some embodiments, the present invention provides a flour mixture comprising least about 15% by mass microfluidized bran. In other embodiments, the flour mixture comprises about 15% by mass microfluidized bran; alternately the flour mixture comprises between about 10% and about 25% by mass microfluidized bran. In still other embodiments, the flour mixture comprises about 30% by mass microfluidized bran. Alternately, the flour mixture comprises no more than about 30% by mass microfluidized bran; alternately between about 10% and about 30% by mass of the flour mixture has been replaced by microfluidized bran. In another embodiment the flour mixture comprises about 40% by mass microfluidized bran. In yet other embodiments, the flour mixture comprises no more than about 40% microfluidized bran. In one variation of any of the disclosed embodiments, the microfluidized bran comprises, consists essentially of or consists of oat bran, corn bran, rice bran, rye bran, barley bran and/or millet bran. In another variation of any of the disclosed embodiments, the microfluidized bran comprises, consists essentially of or consists of corn bran and/or microfluidized oat bran. In a particular variation, the flour mixture comprises at least about 15% by mass microfluidized corn bran and at least about 5% by mass microfluidized oat bran. In one variation of any of the disclosed embodiments, the present application discloses a foodstuff prepared from a flour mixture as disclosed herein.

In some embodiments, the present invention provides a baked good comprising microfluidized bran, wherein the microfluidized bran comprises, consists essentially of or consists of corn bran and/or microfluidized oat bran. In some embodiments, the baked good is prepared from a flour mixture in which at least about 15% of the flour mixture by mass comprises microfluidized corn bran, microfluidized oat bran, or a combination thereof. In another variation, the foodstuff is a baked good prepared from a flour mixture in which at least about 15% of the flour mixture by mass comprises microfluidized corn bran and at least about 5% of the flour mixture by mass comprises microfluidized oat bran. In one variation, the baked good is bread having at least about 10 g dietary fiber/100 g bread.

In some embodiments, the present invention provides a baked good prepared from a flour mixture in which at least about or about 15% of the flour mixture by mass has been replaced by microfluidized bran; alternately between about 15% and about 25% of the flour mixture by mass has been replaced by microfluidized bran. In another variation, the baked good is prepared a flour mixture in which about 30% of the flour by mass has been replaced by microfluidized bran, alternately between about 105 and about 30% of the flour mixture by mass has been replaced by microfluidize bran. Alternately, the flour mixture comprises between about 5% and about 30% by mass microfluidized bran. In another embodiment the flour mixture comprises about 40% by mass microfluidized bran. In yet other embodiments, the flour mixture comprises no more than about 40% microfluidized bran.

In some embodiments, the present invention provides a beverage containing microfluidized bran. In some embodiments, the microfluidized bran in the beverage comprises, consists essentially of or consists of oat bran, wheat bran, corn bran, rice bran, rye bran, barley bran and/or millet bran. In some embodiments, the microfluidized bran comprises, consists essentially of or consists of oat bran, corn bran, einkorn bran, rice bran and/or rye bran. In some embodiments the microfluidized bran comprises, consists essentially of or consists of oat bran.

In some embodiments, foodstuffs comprising microfluidized bran are provided. In one variation, the microfluidized bran comprises oat bran, wheat bran, corn bran, rice bran, rye bran, barley bran and/or millet bran. In one variation, the foodstuff is a soup, salad dressing, dip, sauce, baked good, extruded cereal or beverage. In a particular variation, the foodstuff is a baked good, optionally bread, or a beverage, optionally milk.

In some embodiments, the present invention provides methods of producing foodstuffs having increased fiber content are provided. Such methods may comprise, consist essentially of or consist of adding microfluidized bran to a foodstuff. In one variation, the methods comprise, consist essentially of or consist of microfluidizing bran, collecting the microfluidized bran, optionally via filtration, including but not limited to vacuum filtration, and adding the wet microfluidized bran to a foodstuff. In one variation, the microfluidized bran is dried before incorporating the microfluidized bran into the foodstuff. In one variation, the bran comprises, consists essentially of or consists of oat bran, wheat bran, corn bran, rice bran, rye bran, barley bran and/or millet bran. Alternately, the bran comprises, consists essentially of or consists of oat bran, corn bran, rice bran, rye bran, barley bran and/or millet bran. Alternately, the bran comprises, consists essentially of or consists of oat bran and/or corn bran. In one variation, the foodstuff prepared by the methods disclosed herein has increased fiber content as compared to a control foodstuff lacking microfluidized bran.

### EXAMPLES

The following examples are for illustrative purposes only and are not intended to be a detailed catalogue of all the different ways in which the present invention may be implemented or of all the features that may be added to the present invention. One skilled in the art will appreciate that the following Examples are exemplary and that numerous changes, modifications, and alterations can be employed without departing from the scope of the presently disclosed subject matter.

### Example 1

### Materials and Methods

An M-110P Microfluidizer® Processor (Microfluidics, Newton, Mass.) was used for processing. Raw wheat bran was purchased from ConAgra Foods (Omaha, Neb.); raw corn bran was purchased from Cargill (Paris, Ill.). Raw oat bran was purchased from Bob's Red Mill Natural Foods (Milwaukie, Oreg.).

The compounds 2,2′-azino-bis[3-ethylbenz-thiazoline-6-sulphonate (ABTS), 2,2-diphenyl-1-picrylhydrazyl (DPPH), 3-(2-pyridyl)-5,6-diphenyl-1,2,4-triazine-4′,4″-disulfonic acid monosodium salt (Ferrozine), Folin-Ciocalteu's phenol reagent, potassium ferricyanide (K₃Fe(CN)₆) 6-hydroxy-2,5,7,8-tetramethylchroman-2-carboxylic acid (Trolox), Ethylenediaminetetraacetic acid disodium salt dihydrate (EDTA-Na₂.2 H₂O), Iron (II) chloride, potassium persulfate, ferric chloride (FeCl₃) and L-ascorbic acid were purchased from Sigma-Aldrich (St. Louis, Mo., USA). Gallic acid was obtained from Acros Organics (New Jersey, USA). All the solvents used were of HPLC grade, and other chemicals and reagents were of analytical grade.

Microstructural analysis: Microstructure of raw brans were analyzed by confocal laser scanning microscopy (CLSM). The 3-D confocal images were acquired using an inverted microscope (Axio Observer Z1, Zeiss) with attached Zeiss LSM 700 META imaging system (Carl Zeiss, Jena, Germany). The autofluorescence of bran tissues was detected using two lasers as excitation sources and appropriate long pass filters (a UV argon ion laser, λ_{exc}=405 nm; and a blue argon ion laser, λ_{exc}=488 nm). Images were obtained serially by scanning the section with each laser beam in combination with an appropriate emission filter. Microstructural analysis sheds light on changes in physicochemical and nutritional properties resulting from microfluidization processing.

Particle size distribution: A Bluewave Particle Size Analyzer (Microtrac, Montgomeryville, Pa.) was used to analyze particle size distribution (PSD). PSD parameters include calculated surface which provides an indication of the specific surface area, selected percentile points D90, D50, and D10 which, respectively, represent 90%, 50%, and 10% of the volume that is smaller than the size indicated, mean diameter of the volume distribution, and standard deviation. Each measurement was conducted in triplicate. Both dry particles and wet particles (where the dispersant was water) were analyzed.

Swelling capacity (SC) is defined as the settled bed volume occupied by a known amount of fiber ingredients under the conditions used. Briefly, weighted dry bran sample (0.5±0.001 g) was added to distilled water (20 ml) in a 25-ml graduated cylinder; the mixture was stirred to remove trapped air. The cylinder was then covered with parafilm and left undisturbed at room temperature overnight for complete hydration. The volume (ml) occupied by the settled sample was recorded. Swelling capacity is generally expressed as volume of swollen sample (ml) per gram dry sample.

Water-holding capacity (WHC) is defined as the amount of water retained by a known amount of fiber ingredients under the conditions used. In brief, weighted dry bran sample (0.5±0.001 g) was added to 20 ml distilled water in a 50-ml centrifuge tube and allowed to hydrate at room temperature for 24 h. After centrifugation at 2,000×g for 10 min, the supernatant was carefully removed with a pipette. The tube was then inverted and left to drain for 5 min, after which the weight of hydrated wheat bran was recorded. WHC is generally expressed as grams of water per grams of dry sample.

Viscosity of aqueous suspension: Sample slurries containing 5% (wt/wt) bran powder were prepared by slowly adding an appropriate amount of bran to distilled water and mixing at high speed using a Waring blender for one minute. The mixture was allowed to fully equilibrate at room temperature for 24 h. The viscosity was measured using a Haake VT 550 (Haake USA, Paramus, N.J.) viscometer at 25° c. Insoluble fibers can elevate digesta viscosity, which can diminish nutrient absorption. Self-diffusion of nutrients in digesta in the lumen correlates negatively with digesta viscosity.

Oil-holding capacity: The oil-holding capacity (OHC) was determined by following the procedure for WHC test as described above where water is replaced by soybean oil (density of 0.917 g ml−1 at 25° C.) or other oils as disclosed herein.

Moisture content: Moisture content in the microfluidized brans was measured using the AACC Method 44-15A (AACC International, 2000. Approved methods of the American Association of Cereal Chemists (10th ed). Method 44-15A, AACC International, St. Paul, Minn.).

Cation exchange capacity: The method reported by Chau and Cheung (Chau, C. F., & Cheung, P. C. K. (1999), “Effects of the physico-chemical properties of three legume fibers on cholesterol absorption in hamsters” Nutrition Research, 19, 257-265) was used. The cation-exchange capacity is generally expressed as the number of milliequivalents per kilogram of dry sample.

Solvent retention capacity: Solvent retention capacity (SRC) is defined as the weight of solvent held by cereal flour after centrifugation and expressed as the percentage of flour weight (14% moisture basis). Four solvents were independently used to produce four SRC values: water SRC, 50% sucrose SRC, 5% sodium carbonate SRC, and 5% lactic acid SRC. Approved Method 56-11 (Gaines, C. S. (2000). Report of the AACC committee on soft wheat flour, Method 56-11, Solvent Retention Capacity Profile, Cereal Foods World, 45, 303-306) was used to measure SRC.

Measurement of nutritional properties of the modified brans: Nutritional properties include fermentation property, antioxidant activity, and bile acid binding capacity. These measurements are informative in part because: 1) fiber is partially fermented in the colon, leading to the production of beneficial metabolites, such as short-chain fatty acids (SCFA) acetate, propionate, and butyrate; 2) fiber-bound phenolic compounds may exert antioxidant activity by a surface reaction phenomenon; they may be released or remain bound when reaching the colon, counteracting dietary pro-oxidants and thus may reduce the risk of colorectal cancer; and 3) dietary fibers are capable of binding different bile acids and thereby reducing serum cholesterol.

### Phenolic Content Analysis

Solvent extractable phenolic compounds: Briefly, 1 g untreated or microfluidized bran sample was extracted three times with 20 mL of 50% acetone for 20 min with shaking. The supernatant was collected by centrifugation at 8000 g for 10 min, evaporated in vacuum, reconstituted in 10 mL of DMSO/methanol (50:50, v/v) and stored at −30° C. until analysis.

Alkaline and acid hydrolysable phenolic compounds: The residue after the solvent extraction was air-dried for 12 h and hydrolyzed with 2 M NaOH at room temperature for 4 h with shaking under nitrogen. The resulting hydrolysate was acidified to pH 2 with 6 M HCl and centrifuged. The bran residue obtained was air dried for 12 h and hydrolyzed with 6 M HCl at 95° C. for 1 h. The value of pH for the resulting hydrolysate was then adjusted to 2 and centrifuged. The final bran residue obtained was air dried for other analyses. Each supernatant from alkaline and acid hydrolysis was extracted with hexane for five times to remove lipid contaminants. The liberated phenolic compounds were then extracted with ethyl acetate for six times and subsequently evaporated to dryness. The extracts were reconstituted in 10 mL of DMSO/methanol (50:50, v/v) and stored at −30° C. until analysis.

### Determination of Total Phenolic Content of Bran

Direct procedure for ground raw, microfluidized bran and the residue after alkaline and acid hydrolysis: The content of surface-reactive phenolic compounds of ground raw, microfluidized bran and the residue after alkaline and acid hydrolysis was determined by as follows. Briefly, 10 mg powdered bran sample was mixed with 2.5 mL of Folin-Ciocalteu reagent (10%, wt/wt, in distilled water) in a centrifuge tube. After 5 min, 2 mL of sodium carbonate aqueous solution (7.5%, wt/wt) was added. The mixture was then incubated for 2 h at room temperature and vortexed several times during the incubation. The mixture was then centrifuged at 10,000 rpm for 15 min. The supernatant was collected and absorbance at 725 nm was measured using a Shimadzu variable wavelength UV—vis spectrophotometer (model 2500). A standard curve with serial gallic acid solutions was used for calibration. Results were expressed as mg of gallic acid equivalents (GAE) per gram of dry weight (d.w.). A solution was additionally diluted with cellulose when the solution absorbance exceeded the linear range of the standard curve.

Contents of solvent extractable, alkaline and acid hydrolysable phenolic compounds: The phenolic content of the extracts and hydrolysates was quantified according to the modified Folin-Ciocalteau method as reported in a previous study (Wang, T., et al., (2009). “Total phenolic compounds, radical scavenging and metal chelation of extracts from Icelandic Seaweeds” Food Chemistry, 116, 240-248). Results are expressed as mg of gallic acid equivalents (GAE) per gram of dry weight (d.w.).

Antioxidant activity: Activity is measured using the ABTS [2,2′-azinobis(3-ethylbenzothiazoline-6-sulfonic acid)] and DPPH (2,2-diphenyl-1-picrylhydrazil) methods described below and expressed as millimole of Trolox equivalent antioxidant capacity (TEAC) per kilogram sample by means of a dose-response curve for Trolox.

ABTS Method. The ABTS reagent was prepared by incubating 7 mmol/L ABTS aqueous solution with 2.45 mmol/L potassium persulfate and allowing the mixture to stand in the dark at room temperature for 12-16 h before use. The solution was further diluted with a mixture of ethanol:water (50:50 v/v) to obtain an absorbance of 0.70±0.02 at 734 nm. Ten mg of a bran sample was mixed with 6 mL ABTS reagent. The mixture was vortexed periodically throughout the 60 min incubation period, generally to facilitate reaction between the bran and the ABTS reagent. After centrifugation at 10,000 g for 5 min, the absorbance of the optically clear supernatant was recorded at 734 nm using a Shimadzu variable wavelength UV—vis spectrophotometer (model 2500). A calibration curve was prepared with different concentrations of Trolox (ranging from 0 to 0.2 mmol/L) and the results were expressed in terms of Trolox equivalent antioxidant capacity (TEAC, μmol Trolox equivalents/g d.w.). Additional dilution was made with cellulose when the absorbance was over the linear range of the standard curve.

DPPH Method: DPPH radical was prepared freshly in 80% of aqueous methanol at 64 μM. the incubation time was 2 h and the absorbance was measured at 515 nm. Ten mg powdered bran sample were mixed with 1.7 mL of DPPH reagent. The mixture was vortexed for 3 min at 0, 15, and 25 min to facilitate reaction between the insoluble matter and the DPPH reagent. Following centrifugation at 9200 g for 2 min, the absorbance of the optically clear supernatant was measured at 517 nm (Shimadzu model 2500 variable wavelength UV—vis spectrophotometer). All measurements were performed 2 h after mixing the insoluble matter with the DPPH reagent. The scavenging activity of the sample was calculated relative to that of Trolox on a molar basis and the results were expressed as μmol Trolox equivalents per g of dry weight.

Measurement of Reducing Power: Ten mg of bran sample was mixed with 2.5 mL of phosphate buffer (0.2 M, pH 6.6) and 2.5 mL of 1% potassium ferricyanide [K₃Fe(CN)₆]. After 20 min incubation at 50° C., 2.5 mL of 10% trichloroacetic acid was added and the mixture was centrifuged at 11,000 g for 10 min. The supernatant (1 mL) was mixed with 2.5 mL HPLC-grade water and 0.5 mL of ferric chloride solution (0.1%). After 10 min at room temperature with occasional shaking, the absorbance was measured at 700 nm. The relative activity of the sample was calculated in relation to the reactivity of ascorbic acid standards (0-100 μg/mL) and the results were expressed as mg of ascorbic acid equivalents (ASE) per g of d.w.

Measurement of ferrous ion-chelating ability: Ten mg of bran sample was mixed with 6 mL of distilled water and 100 μL of 2 mM FeCl₂. The reaction was initiated by adding 200 μL of 5 mM ferrozine. The mixture was shaken vigorously for 10 min. After centrifugation at 11,000 g, the absorbance of the supernatant was measured at 562 nm. EDTA-Na₂ was used as reference standard. The results were expressed as μmol EDTA equivalents per g of d.w.

### Example 1-1

### Preparation of Samples

Raw brans were intensively washed using deionized water, typically to remove flour residues and other floating impurities. The washed samples were then air dried at about 35° C. for about 48 hr. Each bran sample was ground (Waring variable speed laboratory blender (Model MX-LB10S)) and passed through a sieve with a known pore size, for example a U.S. Standard No. 35 with a nominal opening of 500 μm (Fisher Scientific Co., TX, USA)). In this way, samples of brans with a maximal particle size of 500 μm were prepared. Finally, each sample was dispersed in deionized water to prepare dispersions at a concentration up to 20% (wt/wt) for example, when an IC200 is used in the processing. Other solid concentration levels, such as 1%, 5%, 7.5%, 10%, or 15% (wt/wt) can be prepared in dispersion as appropriate.

Conditions for microfluidization processing, unless otherwise indicated, were generally 200 μm interaction chamber, room temperature (22-24° C.), 18000-24000 psi pressure, and 1-5 passes through the microfluidizer. Since the interaction chamber micro-channel could be clogged by solid particles suspended in the liquid stream, there was generally a maximal particle size and maximal solid concentration at a given size of the interaction chamber and processing pressure. For wheat and corn brans, there was no clogging for an IC200 when the maximum bran particle size was smaller than 500 μm, processing pressure was higher than 18000 psi, and bran concentration was lower than 20% (wt/wt). To determine the maximal particle size and maximal solid concentration in an experimental pressure range, each of the prepared dispersions were processed through the microfluidizer at each pressure from low to high at 1,000 psi intervals. The dispersion which allowed a smooth process without clogging the micro-channel was identified and the particle size and solid concentration was determined for each processing pressure. Using different equipment, a similar approach can be used to identify variations in maximal particle size and maximal solid concentration at a given processing pressure.

Typically, subsequent passes through any size of interaction chamber resulted in smaller stepwise decreases in the particle size. On the other hand, the width of the particle size distribution generally decreased with an increase in the number of passes.

Raw bran samples were processed under each set of the process conditions illustrated herein by following the above established processing protocol. As indicated below, high moisture (30% wt/wt, wet basis) bran samples obtained directly from vacuum filtration were incorporated into bread. Alternately, brans in the processed suspensions were collected by vacuum filtration or centrifugation and air dried at a suitable temperature to a moisture content of about 10% (wt/wt, wet basis).

### Example 1-2

Studies on wheat bran demonstrated the effectiveness of microfluidization in modifying bran. Commercial raw wheat bran was ground using a Waring variable speed laboratory blender (Model MX-LB10S) and passed through a U.S. standard No. 35 sieve with a nominal opening of 500 μm (Fisher Scientific Co., TX, USA). Suspensions of the obtained bran (3% wt/wt) were then prepared in water and processed through a 200 μm interaction chamber at about 25,000 psi and room temperature for 1-3 passes.

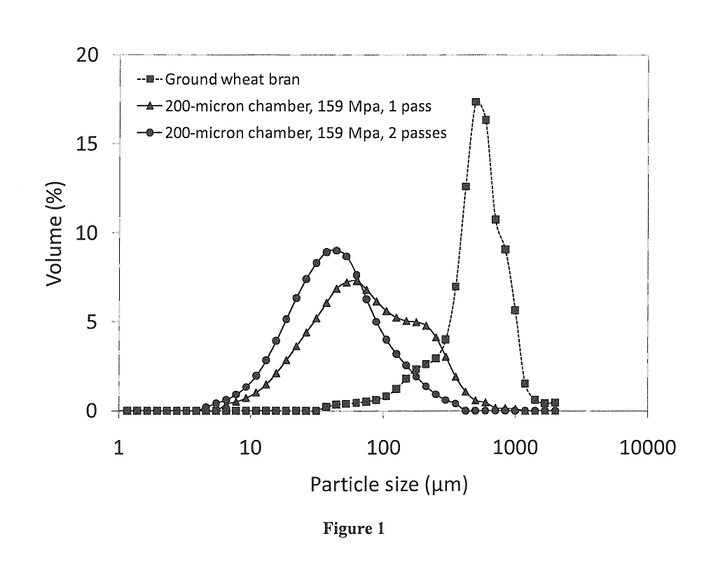

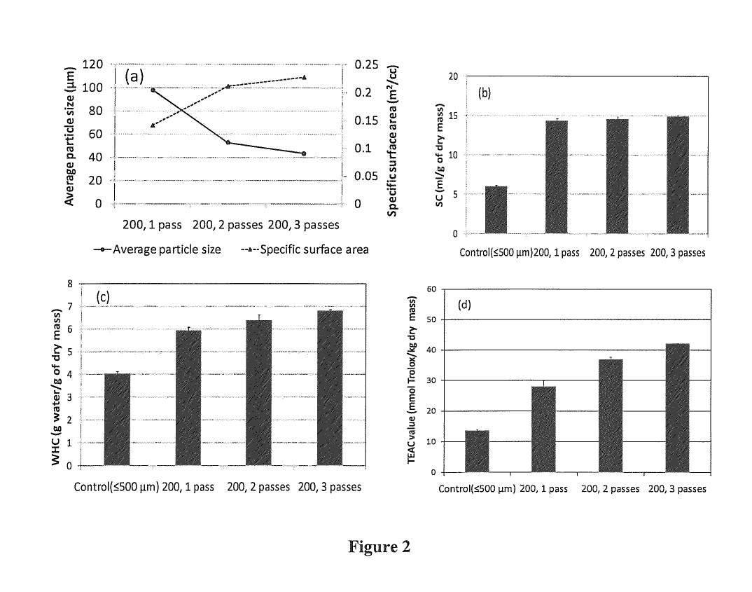

A typical particle size distribution of wheat bran particles before and after microfluidization is shown in FIG. 1. For ground wheat bran, 50% of the particle volume was comprised of particles having a diameter between about 35 μm and about 460 μm, 10% of the total particle volume was comprised of particles having a diameter between about 35 μm and about 265 μm, and 10% of the total particle volume was comprised of particles having a diameter between about 660 μm—and about 2000 μm (maximum size). Particles with a size between about 5 μm and about 500 μm accounted for about 55% of the total volume. After two-pass microfluidization, 50% of particle volume of the microfluidized bran was comprised of particles having a diameter between about 5 μm and about 40 μm, 10% of the total particle volume was comprised of particles having a diameter between about 5 μm and about 15 μm, and 10% of the total particle volume was comprised of particles having a diameter between about 110 μm and about 350 μm. Particles with a size between about 5 μm and about 110 μm accounted for about 90% of the total volume. The resulting particle size reduction and increase in specific surface area are illustrated in FIG. 2. Particle size reduction and microstructure change lead to an increase in swelling capacity (SC) (FIG. 2), water holding capacity (WHC) (FIG. 2), and total antioxidant capacity (FIG. 2) as indicated by trolox equivalent antioxidant capacity (TEAC) values (mmol Trolox/kg dry mass) which increased from 13.6 (control) to 28.0, 36.9, and 42.0 for one, two, and three passes, respectively.

### Example 1-3

Enriching corn grits with microfluidized wheat bran showed better quality than those with ground wheat bran. Combination products were produced using a laboratory co-rotating twin-screw extruder (Brabender MARK III, CTSE-V).
(a) Corn grits (Cargill Dry Corn Ingredients, Inc., Paris, Ill.) (100%) were used as provided commercially.
(b) Corn grits (70%, wt/wt) were combined with raw wheat bran that was repeatedly ground using a Waring variable speed laboratory blender (Model MX-LB10S) and screened by a 500 μm sieve) (30%, wt/wt), and
(c) Corn grits (70%, wt/wt) were combined with microfluidized wheat bran (IC200, 25,000 psi and 1 pass) (30%, wt/wt)

Samples (a), (b) and (c) were extruded at a constant moisture content (16%, cry basis), screw speed (180 rpm) die temperature (140° C.), feed speed (110 g/min), extruder RPM (180 rpm), extruder temperature (30° C., 80° C., 110° C., 140° C., 140° C. for zones 1-5, respectively, counted from the side of feeder) in a laboratory co-rotating twin-screw extruder (Brabender MARK III, CTSE-V) with barrel diameter 32 mm, and screw length 13 times its diameter. Radial expansion ratio of each sample is determined as extrudate diameter/die diameter. The three extrudates had expansion ratios (product diameter divided by the extruder die diameter) of:
(a) 100% corn grits=2.8
(b) 70% corn grits+30% microfluidized wheat bran=2.3
(c) 70% corn grits+30% raw wheat bran=1.9

Adding a high level of bran to extruded cereals typically causes a reduction in the expansion of the finished products, however, the addition of microfluidized brans has been shown to reduce this negative effect.

### Example 1-4

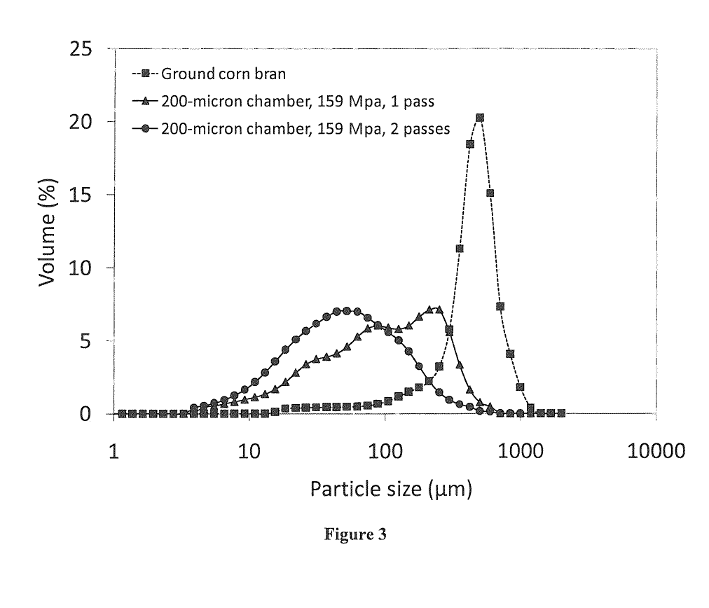

Corn bran was ground using a Waring variable speed laboratory blender (Model MX-LB10S) and dispersed in water at a ratio of bran:water=8:100 (wt/wt). The bran suspension was then processed through an IC₃₀₀ for two passes, whereby bran particles were reduced in size, thereby preventing clogging in the subsequent processing. The suspension was further processed through an IC₂₀₀ at 25,000 psi for 1-3 passes. A typical particle size distribution of corn particles before and after microfluidization is shown in FIG. 3. For ground corn bran, 50% of the particle volume was comprised of particles having a diameter between about 15 μm and about 415 μm, 10% of particles having a diameter between about 15 μm and about 175 μm, and 10% of particles having a diameter between about 635 μm and about 1185 μm (maximum size). Particles with a diameter between about 5 μm and about 500 μm accounted for about 70% of the total volume. After two-pass microfluidization, 50% of particle volume of microfluidized corn bran was comprised of particles having a diameter between about 5 μm and about 45 μm, 10% of the total particle volume was comprised of particles having a diameter between about 5 μm and about 15 μm, and 10% of the total particle volume was comprised of particles having a diameter between about 140 μm and about 350 μm. Particles with a size between about 5 μm and about 140 μm accounted for about 90% of the total volume. The resulting particle size reduction and increase in specific surface area are illustrated in Table 1-1.

TABLE 1-1
Effects of the microfluidization process on properties of corn bran

| | Specific surface | Average particle | Antioxidant capacity | |
|---|---|---|---|---|
| | areas | size in diameter | (mmol TE/kg dry weight) | |
| Bran sample | (m²/cm³) | (μm) | TEAC value | DPPH |
| Ground raw | 0.024 ± 0.001 | 417.1 ± 1.6 | 34.0 ± 0.9 | 22.6 ± 1.2 |
| IC₃₀₀, 2-pass | 0.065 ± 0.002 | 292.1 ± 8.6 | 41.1 ± 0.5 | 29.1 ± 1.5 |
| IC₂₀₀, 1-pass | 0.145 ± 0.006 | 112.2 ± 8.3 | 52.5 ± 2.2 | 41.1 ± 2.5 |
| IC₂₀₀, 2-pass | 0.213 ± 0.002 | 65.1 ± 2.3 | 61.4 ± 1.9 | 46.4 ± 1.3 |

The increased specific surface area and particle expansion corresponded to an increase in antioxidant capacity (Table 1-1). Moreover, after microfluidization, the original strong corny taste was substantially reduced. In particular, the microfluidized corn bran was nearly tasteless when incorporated into a bread product in preliminary tests conducted in the lab, as described below.

### Example 1-5

Bread was prepared by substituting white flour with microfluidized corn and oat brans, using a home-style bread maker (one pound) as disclosed herein.

Variations of the process disclosed herein include the number of passes for bran microfluidizaiton, different sized interaction chambers, corn bran substitution level, and oat bran substitution level.

Preparation of corn bran I: Raw corn bran (Cargill, Paris, Ill.) was ground using a S102DS Lab Grinder (Strand Manufacturing Company, Inc., Hopkins, Minn.). The ground bran was dispersed in deionized water at a ratio of corn bran:water=8:100 (wt/wt). The suspension was processed through an M-110P Microfluidizer Processor (Microfluidics, Newton, Mass. USA) with a 300 μm interaction chamber at 10,000 psi and room temperature for two passes. The corn bran suspension was further processed with a 200 μm interaction chamber at 25,000 psi and room temperature for 1-5 passes. The processed bran samples were collected by vacuum filtration.

Preparation of corn bran II: Raw corn bran (Cargill, Paris, Ill.) was ground using a S102DS lab Grinder (Strand Manufacturing Company, Inc. Hopkins, Minn.) and passed through a U.S. standard No. 35 sieve with a nominal opening of 500 μm (Fisher Scientific Co., TX, USA). Suspensions of the obtained bran (typically less than 22% (wt/wt), such as, for example, 15% or 20% (wt/wt)) were then prepared in water and processed through a 200 μm interaction chamber at about 23,000 psi and room temperature for different passes. The processed bran samples were collected by vacuum filtration.

Oat bran (Bob's Red Mill Natural Foods, Milwaukee, Wis.) was ground and dispersed in deionized water at a ratio of oat bran:water=30:70 (wt/wt). The suspension was processed through a 300 μm interaction chamber at 8,000 psi and room temperature for one pass.

Bob's Red Mill Organic Unbromated Unbleached White Flour milled from extra high protein, high gluten U.S. #1 dark northern hard red wheat was used for making bread.

Bread making I: The formula, based on 100 g flour or blended flour and bran, was 56% water, 7.5% sugar, 3.75% dry milk, 1% salt, 0.9% yeast and 5% butter.

The following dough formulations based on 100 g blended flour and bran, were prepared with the balance being commercially available unbleached white flour:
a) 18% microfluidized corn bran
b) 18% microfluidized corn bran+8% microfluidized oat bran,
c) 8% microfluidized corn bran+18% microfluidized oat bran,
d) 18% microfluidized oat bran.

Bread making II: Alternately, dough formulation included dry milk (2 g), sugar (7.5 g), salt (1 g), butter (5 g), pressed baking yeast (0.7 g), and water (required to reach 500 BU of consistency determined by farinographs).

The following dough formulations, based on 100 g blended flour and bran, were prepared with the balance being commercially available unbleached white flour:
a) Between about 18% and 22% microfluidized corn bran
b) Up to about 30% with corn bran and oat bran substituted for white flour, typically about 15% microfluidized corn bran+15% microfluidized oat bran or about 20% microfluidized corn bran+10% microfluidized oat bran
c) Between about 20% and about 25% microfluidized oat bran.

Bread was made using Zojirushi BB-HAC10 bread makers with regular bread cycle. After baking, bread was stored in plastic zip bags after 30 min cooling at room temperature.

### Measurements of Bread Quality Parameters

Crumb's density (g/cm³ crumb): The volume of a weighed amount of crumb was determined after 1 h cooling with a rapeseed displacement method.

Color: Bread crust color (L, a, and b values) were measured with a CM-3500d color meter (Konica Minolta Sensing Americas, Inc., Ramsey, N.J.). L, a, and b values indicate whiteness, red, and yellow, respectively.

Crumb firmness of fresh bread (1 day of storage); Bread with lower crumb firmness has been found to be more acceptable to consumers. Crumb firmness is determined by following the method reported in (Skendi et al., 2010) using a Texture Analyzer TA-XT2i (Stable Microsystems, Surrey, UK) provided with the software “Texture Expert.”

Bread staling: Bread staling is often used to refer to the phenomenon of crumb firming during storage and measured by the increase in crumb firmness. Typically, an increase in crumb firmness decreases consumer acceptance of bread and to some extent makes bread unacceptable and is thus an indicator for shelf life other than spoilage. Bread firmness testing is performed on bread crumbs stored at 4° C. to accelerate the bread staling events for 1,4, 8, 12 days.

Sensory tests: Thirty untrained panelists (15 males and 15 females) are recruited from students and faculty in the Department of Family and consumer Sciences, Participants are given the bran-enriched samples and the white bread (control, made with the same recipe with no substitution of microfluidized bran for white flour) one day after baking. The experiment is designed to that four replicates are obtained for each bread sample. The laboratory is equipped with individually partitioned booths. Drinking water is provided to clean and rinse the mouth between samples. The samples are presented in a random sequence as pieces, placed on white plates, coded with random three-digit numbers, and served under normal lighting conditions at room temperature. A verbally anchored 9-point hedonic scale (1—dislike extremely, 2—dislike very much, 3—dislike moderately, 4—dislike, 5—neither like nor dislike, 6—like, 7—like moderately, 8—like very much, and 9—like extremely) is performed for this test. The chosen quality parameters include crust color, crust shape (flat and uneven and convex shape), crumb color (brown and white), crumb grain (very coarse and very fine), mouthfeel (dough/grainy/sticky, easy break down and clean mouthfeel) and taste (foreign and typical and pleasant).

As disclosed herein, microfluidized corn bran and/or oat bran were integrated into bread together at high concentrations without reducing the loaf volume. Based on observation and preliminary sensory tests, microfluidized corn bran particles were undetectable in the bread, which had only a very slight corn flavor.

These studies also showed that when microfluidized oat bran was added at a suitable concentration to a bread formulation, the microfluidization substantially offset negative effects typically associated with increased fiber content, such as reduced loaf volume and crumb softness.

### Example 1-6a

Rice bran, cleaned, ground and sieved, as described above, is dispersed in distilled water at a ratio of bran:water for example, at 12-18% in water, or 1:50 (wt/wt) or 9:91 (wt/wt). The suspension is then processed using an M-110P Microfluidizer Processor (Microfluidics, Newton, Mass., USA) through interaction chambers with a diameter of 200 μm (IC200) at about 159 MPa at room temperature for 1-2 passes. The resulting microfluidized bran particles are isolated for later use as a component in a baked good or in a beverage or as a base for soups, salad dressings or dips. Typically, the microfluidized rice bran is substituted for flour between about 5% and about 35% (wt/wt), or about 10% to about 25% (wt/wt).

### Example 1-6b

Rye bran, cleaned, ground and sieved, as described above, is dispersed in distilled water at a ratio of bran:water for example, at 12-18% in water, or 1:50 (wt/wt) or 9:91 (wt/wt). The suspension is then processed using an M-110P Microfluidizer Processor (Microfluidics, Newton, Mass., USA) through interaction chambers with a diameter of 200 μm (IC200) at about 159 MPa at room temperature for 1-2 passes. The resulting microfluidized bran particles are isolated for later use as a component in a baked good or in a beverage or as a base for soups, salad dressings or dips. Typically, the microfluidized rye bran is substituted for flour between about 5% and about 35% (wt/wt), or about 10% to about 25% (wt/wt).

### Example 1-6c

Barley bran, cleaned, ground and sieved, as described above, is dispersed in distilled water at a ratio of bran:water for example, at 12-18% in water, or 1:50 (wt/wt) or 9:91 (wt/wt). The suspension is then processed using an M-110P Microfluidizer Processor (Microfluidics, Newton, Mass., USA) through interaction chambers with a diameter of 200 μm (IC200) at about 159 MPa at room temperature for 1-2 passes. The resulting microfluidized bran particles are isolated for later use as a component in a baked good or in a beverage or as a base for soups, salad dressings or dips. Typically, the microfluidized barley bran is substituted for flour between about 5% and about 35% (wt/wt), or about 10% to about 25% (wt/wt).

### Example 1-6d

Millet bran, cleaned, ground and sieved, as described above, is dispersed in distilled water at a ratio of bran:water for example, at 12-18% in water, or 1:50 (wt/wt) or 9:91 (wt/wt). The suspension is then processed using an M-110P Microfluidizer Processor (Microfluidics, Newton, Mass., USA) through interaction chambers with a diameter of 200 μm (IC200) at about 159 MPa at room temperature for 1-2 passes. The resulting microfluidized bran particles are isolated for later use as a component in a baked good or in a beverage or as a base for soups, salad dressings or dips. Typically, the microfluidized millet bran is substituted for flour between about 5% and about 35% (wt/wt), or about 10% to about 25% (wt/wt).

### Example 1-7a

Oat bran, cleaned and ground as described above, was dispersed in distilled water at a ratio of bran:water up to 30:70 (wt/wt). The suspension was then processed using an M-110P Microfluidizer Processor (Microfluidics, Newton, Mass., USA) through interaction chambers with a diameter of 300 μm (IC300) and 200 μm (IC200) at between about 55 MPa and 159 MPa at room temperature for 1-2 passes. The resulting microfluidized bran suspension or paste was used as a component in foodstuffs, such as baked goods or as a base for soups, salad dressings or dips.

In particular, 20 g microfluidized oat bran can be combined with 80 g of water as a base for soup. Other combinations yielding a targeted viscosity can be prepared by changing the ratio of water to microfluidized oat bran.

### Example 1-7b

Oat bran, cleaned and ground as described above, was dispersed in distilled water at a ratio of bran:water up to 20:80 (wt/wt). The suspension was then processed using an M-110P Microfluidizer Processor (Microfluidics, Newton, Mass., USA) through interaction chambers with a diameter of 200 μm (IC200) at 159 MPa at room temperature for 2-3 passes. The resulting milk is used as a beverage or as a base for soups, salad dressings or dips.

### Example 2

### Materials and Chemicals

the commercial wheat bran was cleaned, ground and sieved as described above.

### 2.1. Processing of Wheat Bran by Microfluidization

The wheat bran prepared above was dispersed in distilled water at a ratio of wheat bran:water 1:50 (wt/wt). The suspension was then processed using an M-110P Microfluidizer Processor (Microfluidics, Newton, Mass., USA) through interaction chambers with a diameter of 200 μm (IC200) and 87 μm (IC87) at room temperature. Processing pressures were 159 MPa and 172 MPa for IC200 and IC87, respectively. Bran suspensions were pre-processed by an IC200 for three passes before processing through IC87. Interaction chambers used in this study had a “Z” shape. The processed bran samples were collected by centrifugation and freeze dried. The moisture content of the freeze-dried samples ranged from 5.4 to 6.6%. Dry samples were sealed in air-tight glass containers and stored at −30° C. for analysis. All tests were duplicated.

### 2.2. Measurement of Bulk Density

A bran sample (5 g) was carefully added into a calibrated 25 ml graduated cylinder. Pressure was applied manually until there was no further decrease in sample volume. The packed density was calculated as dry weight per unit volume of sample (g ml⁻¹).

### 2.3. Measurement of Hydration Properties

Hydration properties included swelling capacity and water-holding capacity were measured as described above.

### 2.4. Measurement of Cation-Exchange Capacity

The cationic functional groups of wheat bran samples (300 mg) were initially converted into their acidic forms by continuously stirring overnight at 4° C. in 50 ml of 0.01 N hydrochloric acid and centrifuged for 15 min at 12,000×g. The residue was washed extensively with deionized water until the pH of the supernatant was above 4. The acidic residue was suspended in 25 ml of 0.3 M sodium chloride, stirred for 30 min at room temperature and then titrated with 0.02 N potassium hydroxide. A blank test was performed in the same way using 50 ml of distilled water instead of hydrochloric acid. Cation-exchange capacity was expressed as milliequivalents per kilogram dry sample (meq kg⁻¹ dry sample).

### 2.5. Data Analysis

The microfluidization experiment was conducted in duplicate (n=2) and analysis was performed independently three times (a=3). Analysis of variance (ANOVA) was applied to the data using the Number Cruncher Statistical Software, NCSS 2000 (NCSS, Kaysville, Utah, USA). Significant differences were determined by one way ANOVA and Tukey-Kramer Multiple Comparison Test was used to determine the statistical difference between sample groups. Significance of differences was defined at the 5% level (p<0.05).

### 2.6. Effect of Microfluidization Process on Particle Size Distribution

Particle size distribution characteristics of wheat bran treated under different microfluidization conditions are illustrated in Table 2-1. The table shows that the mean particle size was reduced from 500.0 μm to 98.0 μm and 52.8 μm for the first pass and second pass treatments, respectively, when an IC200 was used. Correspondingly, specific surface area increased from 0.02 m² cm⁻³ to 0.14 m² cm⁻³ and 0.21 m² cm⁻³, respectively. When processed by an IC87, the mean particle size reduced further and the specific surface area increased (Table 2-1).

TABLE 2-1
Effects of microfluidization process on the particle size distribution of wheat bran.

| | CS^{a} | MV^{b} | D10^{c} | D50^{d} | D90^{e} | SD^{f} |
|---|---|---|---|---|---|---|
| Bran sample | (m²/cm³) | (μm) | (μm) | (μm) | (μm) | (μm) |
| Ground raw | 0.018 ± | 500.0 ± | 192.0 ± | 473.5 ± | 812.3 ± | 226.8 ± |
| | 0.001 | 13.4 | 13.1 | 18.6 | 14.0 | 3.8 |
| IC_{200,} 1-pass | 0.141 ± | 98.0 ± | 19.4 ± | 62.5 ± | 222.7 ± | 76.6 ± |
| | 0.003 | 10.0 | 0.2 | 2.0 | 27.1 | 7.4 |
| IC_{200,} 2-pass | 0.211 ± | 52.8 ± | 14.2 ± | 38.1 ± | 109.8 ± | 33.4 ± |
| | 0.002 | 0.3 | 0.1 | 0.1 | 1.1 | 0.2 |
| IC_{200,} 3-pass | 0.227 ± | 43.3 ± | 13.9 ± | 33.3 ± | 81.4 ± | 23.9 ± |
| | 0.002 | 0.1 | 0.1 | 0.3 | 0.3 | 0.1 |
| IC_{87,} 1-pass | 0.262 ± | 35.8 ± | 12.2 ± | 29.0 ± | 65.9 ± | 19.7 ± |
| | 0.000 | 0.2 | 0.1 | 0.1 | 0.8 | 0.3 |
| IC_{87,} 3-pass | 0.364 ± | 23.9 ± | 9.1 ± | 20.2 ± | 42.5 ± | 13.3 ± |
| | 0.006 | 0.1 | 0.2 | 0.2 | 0.2 | 0.1 |
| IC_{87,} 5-pass | 0.448 ± | 18.9 ± | 7.4 ± | 16.3 ± | 32.6 ± | 9.4 ± |
| | 0.001 | 0.3 | 0.1 | 0.1 | 0.9 | 0.3 |

^{a}CS, calculated surface which provides an indication of the specific surface area.
^{b}MV, mean diameter of the volume distribution.
^{c}D90, 90% of the volume that is smaller than the size indicated.
^{d}D50, 50% of the volume that is smaller than the size indicated.
^{e}D10, 10% of the volume that is smaller than the size indicated.
^{f}SD, standard deviation which is one measure of the width of the particle size distribution.

### 2.7. Effect of Microfluidization Process on Microstructure of Wheat Bran

After one-pass microfluidization using an IC200, wheat bran particles were broken down into small fragments. Although the intact aleurone cell walls were partially ruptured, the presence of fragments of pericarp and aleurone layers that remained attached to each other or as separate structures was still recognizable by confocal laser scanning microscopy. When using an IC87 and increasing the number of passes, the particle size kept decreasing and the macromolecular structures were almost completely destroyed and the dissociation of different bran tissues was more pronounced.

### 2.8. Effect of Microfluidization Process on Bulk Density

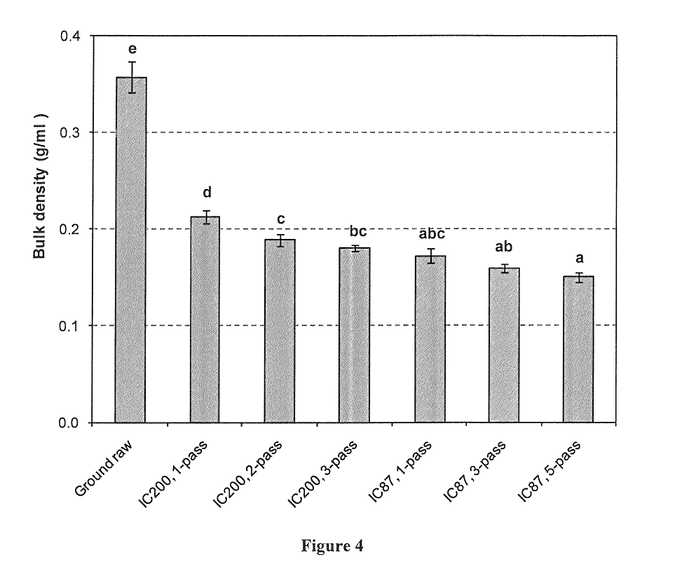

The ground raw wheat bran sample (mean particle size=500 μm) had a bulk density of 0.36 g/ml. Microfluidization changed the particle size distribution, particle shape, and microstructure and thus altered the bulk density (FIG. 4). As shown, bulk density decreased after one-pass microfluidization through an IC200; it continued to decrease in smaller step sizes with additional passes. The reduction of bulk density can attributed to the increase in porosity of microfluidized wheat bran.

### 2.9. Effect of Microfluidization Process on Hydration Properties

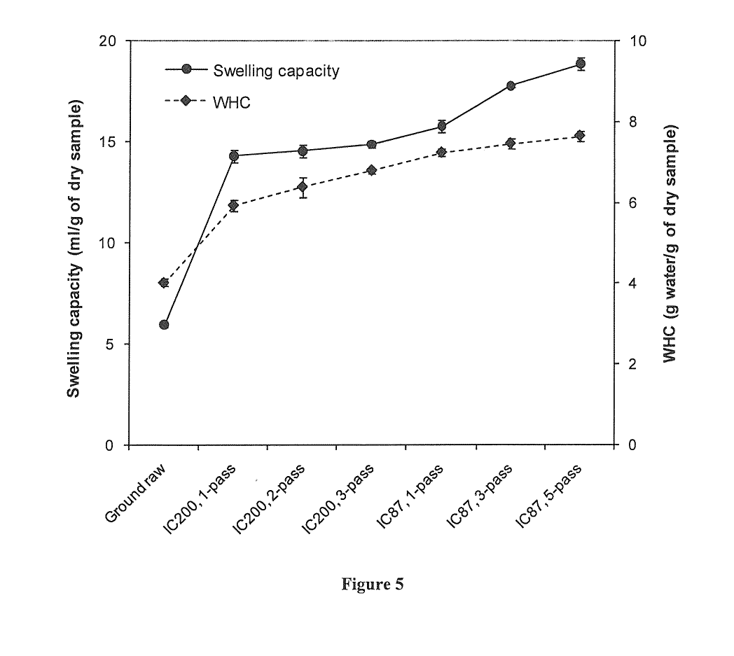

Microfluidization-induced changes of the bran matrix can lead to changes in the bran's hydration properties including water-holding capacity (WHC) and swelling capacity (SC). FIG. 5 shows values of WHC and SC for the raw wheat bran sample and those treated under different microfluidization conditions. As shown, the value of WHC for the raw bran sample was 4.02 g water per g dry sample, which is lower than values for microfluidized wheat bran samples. The value of WHC increased with the decrease in particle size. In addition to particle size distribution, chemical composition and physical changes due to sample preparation also play a role in the WHC of insoluble dietary fibers. As shown in FIG. 5, microfluidization increased the SC. In particular, the first pass through an IC200 resulted in an increase of SC from 5.96 to 14.3 ml/g dry sample. The value of SC continuously increased as particle size decreased under the experimental conditions.

Besides reducing particle size, microfluidization also expanded particles suspended in the liquid stream, generally due to rapid release of pressure at the exit of the interaction chamber of the machine. Without being bound by theory, the expansion likely loosened the microstructure of the particles and created pores or cavities inside the particles. Such microstructure changes along with size reduction exposed a larger surface area and more water binding sites (e.g. polar groups or uronic acid groups) to the surrounding water, thereby enhancing the hydration properties of insoluble fiber ingredients.

### 2.10. Effect of Microfluidization Process on Oil-Holding Capacity

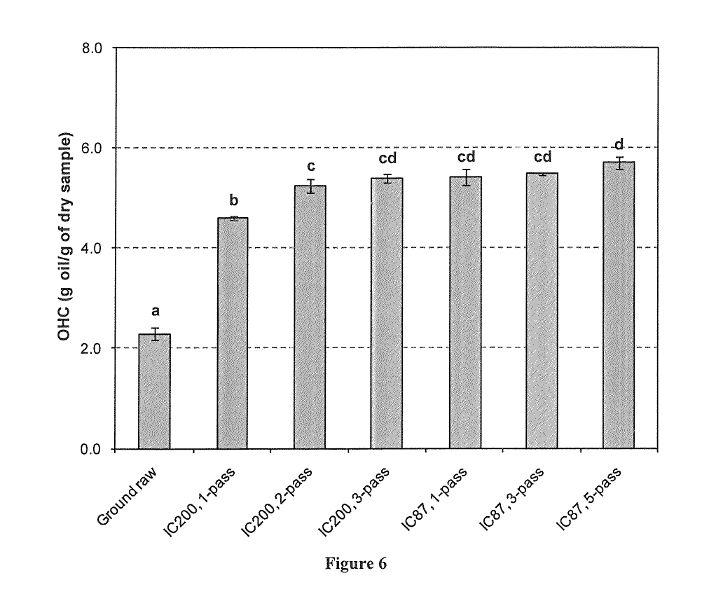

The effect of microfluidization on the oil-holding capacity (OHC) is illustrated in FIG. 6. As shown, the raw wheat bran sample had an OHC of 2.3 g oil per g dry sample. One-pass microfluidization using an IC200 increased OHC from 2.3 to 4.6 g oil per g dry sample; after the second pass, the increase to OHC slowed even as a smaller size interaction chamber (IC87) was used.

### 2.11. Effect of Microfluidization Process on Cation-Exchange Capacity

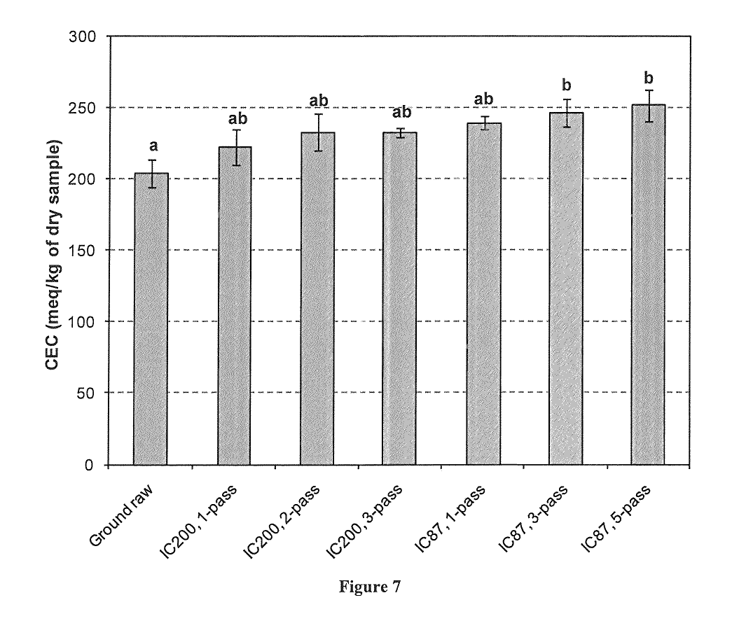

The effect of microfluidization on the cation-exchange capacity (CEC) of wheat bran is shown in FIG. 7. The raw wheat bran had a CEC of 204.1 meq kg⁻¹ dry sample. As shown, CEC increased by 9.1% after one-pass microfluidization using an IC200 and increased slowly with additional treatment; CEC was increased by 23.3% compared with the initial value after five-pass microfluidization using an IC87. Without being bound by theory, the particle size reduction exposed more uronic acids or ion-binding sites on the increased surface area of the samples, and consequently increased the CEC.

### Example 3

### Materials and Chemicals

The commercial wheat bran was cleaned, ground and sieved as described above.

### 3.1. Processing of Wheat Bran by Microfluidization

Ground wheat bran was dispersed in distilled water at a ratio of wheat bran:water 1:50 (wt/wt). The suspension was then processed in a M-110P Microfluidizer Processor (Microfluidics, Newton, Mass., USA) with two sizes of interaction chambers (200 μm (IC200) and 87 μm (IC87) in diameter) at room temperature. Processing pressures were 159 MPa and 172 MPa for IC200 and IC87, respectively. Interaction chambers used in this study had a “Z” shape. Bran suspensions were first processed through the IC200 chamber for 1 to 3 passes. The samples processed with IC87 for 1, 3 or 5 passes were pre-processed by an IC200 for three passes. The processed bran samples were collected by centrifugation and freeze dried. The moisture content of samples ranged from 5.4% to 6.6%. Dry samples were sealed in air-tight glass containers and stored at −30° C. for analysis. All tests were duplicated.

### 3.2. Investigation of Microfluidized Sample

The analysis of the phenolic compounds, the measurement of reducing power and the measurement of ferrous ion-chelating ability, as well as the determination of ABTS and DPPH radical scavenging activities of the microfluidized bran sample followed the procedures described herein.

### 3.3. Statistical Analysis

The microfluidization experiment was replicated two times (n=2) and analyses were performed independently three times (1=3). Analysis of variance (ANOVA) was applied to the data using the Number Cruncher Statistical Software, NCSS 2000 (NCSS, Kaysville, Utah, USA). Significant differences were determined by one-way ANOVA and Duncan's Multiple-Comparison Test was used to determine the statistical difference between sample groups. Significance of differences was defined at the 5% level (p<0.05).

### 3.4 Results and Discussion

The microfluidizaiton process increased specific surface area of wheat bran, without being bound by theory, specific surface area increased by particle size reduction and by loosening the microstructure of bran materials, as well as by exposing more functional groups to the surrounding liquid phase. These changes in turn influenced the solvent extractable, alkaline and acid hydrolysable phenolic compounds and increase the exposure of antioxidant functional groups, thus improving their antioxidant capacity.

### 3.5. Effect of Microfluidization on Surface-Reactive Phenolic Compounds

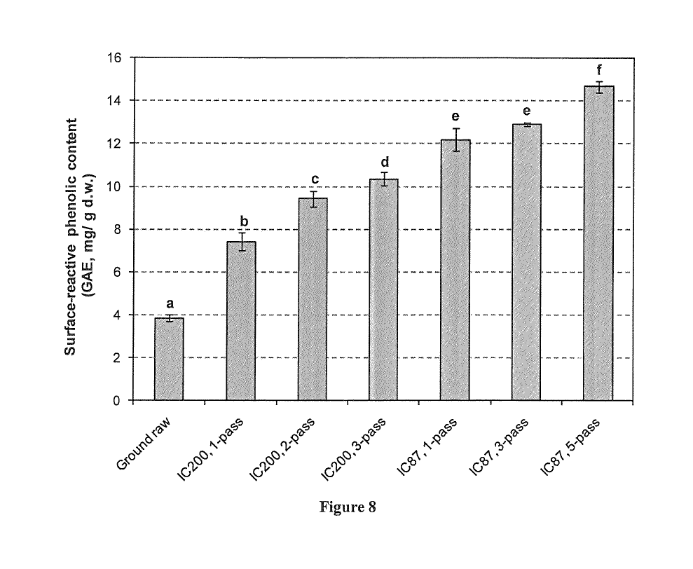

Both free phenolic compounds and those phenolic compounds bound to insoluble components of wheat bran can react with Folin-Ciocalteau reagent when their functional groups are exposed to the fiber surface and accessible for surface reactions. FIG. 8 shows the content of surface-reactive phenolic compounds of ground raw and microfluidized wheat bran. As shown in FIG. 8, the surface-reactive phenolic content increased with microfluidization from 3.9 to 7.4 mg GAE/g d.w. after one pass through a 200 μm chamber and was about 3.8 times of the untreated counterpart after a total of 8 passes through IC200 (3 passes) and IC87 (5 passes) chambers. Microfluidization appeared to cause a slight change in chemical composition of wheat bran as a result of the loss of water-soluble substances, including phenolic acids present in the bran.

### 3.6. Effect of Microfluidization on Antioxidant Capacity of Wheat Bran

In the present study, the antioxidant capacity was assessed by ABTS cation radical scavenging capacity, DPPH radical scavenging activity, reducing power and ferrous ion-chelating ability.

### 3.6.1. ABTS Cation Radical Scavenging Capacity

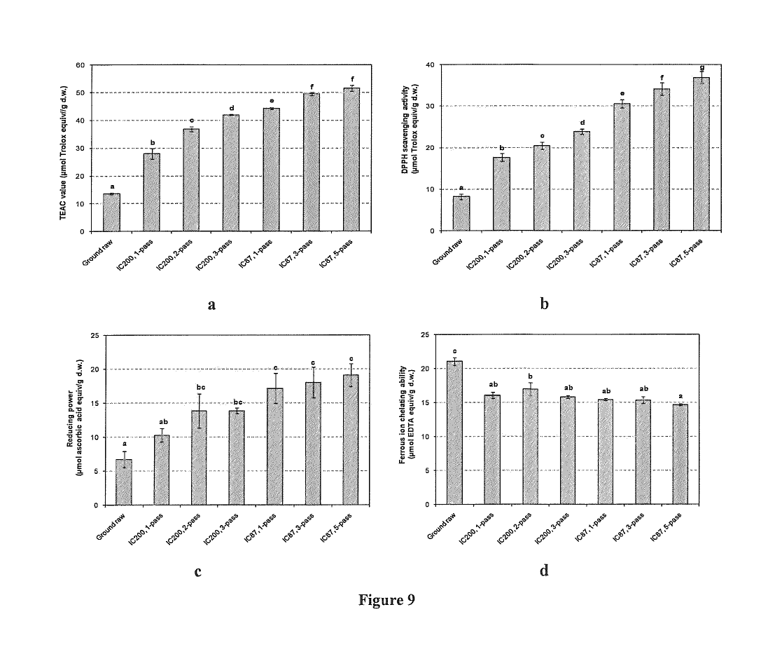

FIG. 9a illustrates the ABTS cation radical scavenging activity of ground raw and microfluidized wheat bran. As shown, the TEAC values increased with increased microfluidization; the highest value was 3.8 times of the untreated control (13.6 μmol trolox equivalent/g d.w.). Positive correlations were observed between the content of surface-reactive phenolics and ABTS cation radical scavenging capacity for all of the microfluidized wheat bran samples based on the Pearson correlation analysis (r=0.975).

### 3.6.2 DPPH Radical Scavenging Activity

FIG. 9b illustrates the DPPH radical scavenging activity of ground raw and microfluidized wheat bran. As shown, increased microfluidization increased the trapping of DPPH. The strongest scavenging activity was seen in the microfluidized wheat bran sample after a total of 8 passes through IC200 and IC87, yielding a sample with activity that was approximately 4.4 times of untreated wheat bran.

### 3.6.3. Reducing Power

As shown in FIG. 9c, the reducing power of wheat bran increased from 6.7 to 19.1 mg ASE/g d.w. after a total of 8 passes through IC200 and IC87 chambers.

### 3.6.4. Ferrous Ion-Chelating Activity

FIG. 9d shows that the ferrous ion-chelating activity of wheat bran decreased as microfluidization increased, but the difference was not statistically significant (p>0.05). Without being bound by theory, the decrease in metal-chelating capacity could be due to the loss or degradation of the constituents that contribute to metal chelation, or reduced number of metal ion-binding sites in the fiber matrix due to the microstructural changes.

### 3.7. Effect of Microfluidization on Solvent Extractable and Hydrolysable Phenolic Contents

The solvent extractable phenolic content of the untreated wheat bran was 0.68 mg GAE/g d.w. As shown in Table 3-1, the solvent extractable phenolic content decreased with microfluidization.

TABLE 3-1
Phenolic content of different phenolic extract and fractions of
ground raw and microfluidized wheat bran ⁽¹⁾

| Sample | Solvent | Alkaline | Acid | |
|---|---|---|---|---|
| group | Extractable | hydrolysable | hydrolysable | Final residue |
| Ground raw | 0.68 ± 0.03^{c} | 5.32 ± 0.16^{a} | 2.33 ± 0.09^{a} | 6.50 ± 0.15^{a} |
| IC₂₀₀, 1-pass | 0.38 ± 0.02^{b} | 6.57 ± 0.22^{b} | 2.46 ± 0.03^{a} | 7.18 ± 0.27^{ab} |
| IC₂₀₀, 2-pass | 0.34 ± 0.01^{ab} | 6.93 ± 0.27^{bc} | 2.44 ± 0.06^{a} | 7.53 ± 0.37^{abc} |
| IC₂₀₀, 3-pass | 0.36 ± 0.01^{ab} | 7.19 ± 0.14^{bcd} | 2.50 ± 0.11^{a} | 7.82 ± 0.19^{bc} |
| IC₈₇, 1-pass | 0.33 ± 0.01^{ab} | 7.82 ± 0.29^{cde} | 2.58 ± 0.10^{a} | 8.20 ± 0.42^{bc} |
| IC₈₇, 3-pass | 0.29 ± 0.01^{a} | 8.29 ± 0.42^{de} | 2.63 ± 0.14^{a} | 8.37 ± 0.20^{bc} |
| IC₈₇, 5-pass | 0.32 ± 0.01^{ab} | 8.62 ± 0.44^{e} | 2.70 ± 0.15^{a} | 8.57 ± 0.40^{c} |

Each value is expressed as means ± S.D. (n = 2, a = 3).
Values in the same column followed by different superscript letters are significantly different (P < 0.05).
⁽¹⁾ For solvent extractable, alkaline and acid hydrolysable phenolic fractions, the results were expressed as mg of gallic acid equivalents (GAE) per gram of dry weight (d.w.) of wheat bran; for the final residue after the alkaline and acid hydrolysis, the result was expressed as mg GAE per gram of d.w. of residue.

The majority of the phenolic compounds present in wheat bran are in the bound form and so are not extractable by organic solvents but can be released by alkaline and acid hydrolysis. Table 3-1 illustrates the effect of microfluidization on alkaline and acid hydrolysable phenolic contents. Phenolic content (via alkaline hydrolysis) increased with microfluidization, while phenolic content (via acid hydrolysis) increased only slightly with microfluidization. The increase in the hydrolysable phenolic contents was attributed to particle size reduction and changes in the microstructure of the fiber matrix as revealed by CLSM. Without being bound by theory, it is believed that the structural changes facilitated exposure of phenolic compounds that are otherwise covalently linked to or tightly embedded in the fiber matrix. The combined effects increased the accessibility of bound phenolics for hydrolysis. As shown herein, hydrolysis methods and conditions have an impact on the total yield and profile of phenolic acids.

The surface-reactive phenolic contents of the residues obtained after alkaline and acid hydrolysis are shown in Table 3-1. The residues contained a fairly high content of surface-reactive phenolic compounds, although complete cleavage of all the ester and ether bonds was not apparently achieved. The surface-reactive phenolic contents of the residues increased with the increase of the extent of microfluidization within the experimental range.

The antioxidant capacity of each fraction of phenolic compounds was analyzed (Table 3-2). As expected, the changes of antioxidant capacity with microfluidization followed the similar trends to those for the phenolic content. The alkaline hydrolysable fractions had greater antioxidant activities in terms of antioxidant capacity per unit amount of phenolic compounds than the acid hydrolysable fractions.

TABLE 3-2
Trolox equivalent antioxidant capacity (TEAC)
of different phenolic extract and fractions of ground
raw and microfluidized wheat bran ⁽¹⁾

| Sample | Solvent | Alkaline | Acid | |
|---|---|---|---|---|
| group | Extractable | hydrolysable | hydrolysable | Final residue |
| Ground | 5.29 ± 0.06^{f} | 49.53 ± 1.21^{a} | 6.46 ± 0.11^{a} | 34.82 ± 1.13^{a} |
| raw | | | | |
| IC₂₀₀, | 4.35 ± 0.07^{e} | 56.58 ± 2.40^{ab} | 9.20 ± 0.50^{b} | 44.76 ± 1.01^{b} |
| 1-pass | | | | |
| IC₂₀₀, | 4.03 ± 0.08^{d} | 61.13 ± 0.81^{bc} | 10.67 ± 0.70^{bc} | 46.20 ± 2.17^{bc} |
| 2-pass | | | | |
| IC₂₀₀, | 3.40 ± 0.09^{c} | 66.54 ± 4.52^{bc} | 11.74 ± 0.35^{c} | 48.05 ± 1.01^{bc} |
| 3-pass | | | | |
| IC₈₇, | 2.53 ± 0.03^{b} | 72.34 ± 3.96^{cd} | 12.09 ± 1.10^{c} | 51.63 ± 3.65^{bcd} |
| 1-pass | | | | |
| IC₈₇, | 1.83 ± 0.08^{a} | 77.87 ± 1.12^{d} | 11.45 ± 0.47^{bc} | 53.98 ± 1.86^{cd} |
| 3-pass | | | | |
| IC₈₇, | 1.86 ± 0.02^{a} | 81.90 ± 3.41^{d} | 12.27 ± 0.73^{c} | 57.80 ± 2.71^{d} |
| 5-pass | | | | |

Each value is expressed as means ± S.D. (n = 2, a = 3)
Values in same column followed by different superscript letters are significantly different (P < 0.05).
⁽¹⁾ For solvent extractable, alkaline and acid hydrolysable phenolic fractions, the results were expressed as μmol Trolox equivalents per gram of dry weight (d.w.) of wheat bran; for the final residue after the alkaline and acid hydrolysis, the result was expressed as μmol Trolox equivalents per gram of d.w. of residue.

### Example 4

### Materials and Chemicals

Commercial fine grind corn bran (Cargill Dry Corn Ingredients, Inc., Paris, Ill., USA) was cleaned and sieved as described above.

### 4.1. Microfluidization Processing of Corn Bran

The corn bran prepared as described above was dispersed in distilled water at a ratio of corn bran:water 1:50 (wt/wt). The suspension was then processed in a M-110P Microfluidizer Processor (Microfluidics, Newton, Mass. USA) with three sizes of interaction chambers: 300 μm (IC300), 200 μm (IC200) and 87 μm (IC87) in diameter, at room temperature. Processing pressures were 159 MPa for IC300 and IC200 and 172 MPa for IC87, respectively. Interaction chambers used in this study had a “Z” shape. Bran suspensions were processed sequentially through the IC300 for two passes, IC200 for 1 and 2 passes, and IC87 for 1, 3 and 5 passes. The processed bran samples after designated passes were collected by centrifugation and freeze dried. The moisture content of the freeze-dried samples ranged from 3.5 to 5.3%. Dry samples were sealed in air-tight glass containers and stored at −30° C. for analysis. All experiments were performed in duplicate.

### 4.3. Measurement of Bulk Density

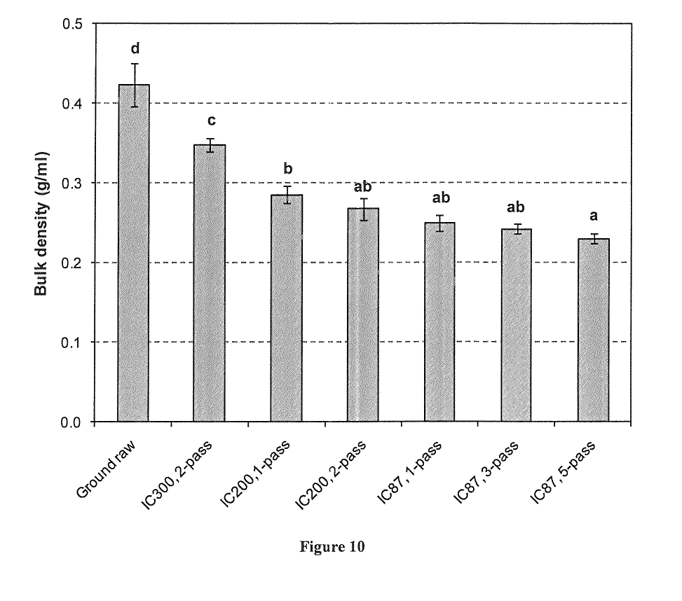

A weighed amount of corn bran sample (5.0 g) was carefully added into a calibrated 25 ml graduated cylinder. Pressure was applied manually until there was no further decrease in sample volume. The packed density was calculated as dry weight of sample per unit volume of sample (g ml−1). The results are shown in FIG. 10.

### 4.4. Measurement of Hydration Properties

Hydration properties including swelling capacity and water holding capacity were measured using the methods identified above.

### 4.5. Measurement of Cation-Exchange Capacity

The cationic functional groups of corn bran samples (300 mg) were initially converted into their acidic forms by continuously stirring overnight at 4° C. in 50 ml of 0.01 N hydrochloric acid and centrifuged for 15 min at 12,000×g. The residue was washed extensively with deionized water until the pH of the supernatant was above 4. The acidic residue was suspended in 25 ml of 0.3 M sodium chloride, stirred for 30 min at room temperature and then titrated with 0.02 N potassium hydroxide. A blank test was performed in the same way using 50 ml of distilled water instead of hydrochloric acid. The cation-exchange capacity was expressed as milliequivalents per kilogram dry sample (meq kg⁻¹ dry sample).

### 4.5. Data Analysis

The microfluidization experiment was conducted in duplicate (n=2) and analysis was performed independently three times (a=3). Analysis of variance (ANOVA) was applied to the data using the Number Cruncher Statistical Software, NCSS 2000 (NCSS, Kaysville, Utah, USA). Significant differences were determined by one way ANOVA and Turkey-Kramer Multiple-Comparison Test was used to determine the statistical difference between sample groups. Significance of differences was defined at the 5% level (p<0.05).

### Results and Discussion

### 4.6 Effect of Microfluidization on Particle Size Distribution

Particle size distribution characteristics of corn bran treated under different microfluidization conditions were determined (Table 4-1). As shown, ground raw corn bran powder had an average particle size of 417.1 μm and a relatively broad particle size distribution (SD=159.2 μm). Microfluidization using an IC300 had a small effect on particle size and the mean particle size was 292.1 μm after the second pass treatment. A decrease in particle size was observed when an IC200 was used: the mean particle size dropped to about 73% and 84% of the original value after the first and second pass, respectively. Correspondingly, specific surface area increased from 0.024 m²/cm³ (ground raw corn bran) to 0.145 m²/cm³ and 0.213 m²/cm³, respectively. When processed by an IC87, the mean particle size was further reduced and the specific surface area was increased.

Table 4-1
Effects of microfluidization process on the particle size distribution of corn bran.

| Bran | CS^{a} | MV^{b} | D10^{c} | D50^{d} | D90^{e} | SD^{f} |
|---|---|---|---|---|---|---|
| sample | (m²/cm³) | (μm) | (μm) | (μm) | (μm) | (μm) |
| Ground raw | 0.024 ± 0.001 | 417.1 ± 1.6 | 175.1 ± 4.8 | 414.9 ± 0.9 | 634.6 ± 9.0 | 159.2 ± 4.3 |
| IC_{300,} 2-pass | 0.065 ± 0.002 | 292.1 ± 8.6 | 38.1 ± 1.2 | 300.5 ± 8.5 | 515.5 ± 8.9 | 194.8 ± 1.6 |
| IC_{200,} 1-pass | 0.145 ± 0.006 | 112.2 ± 8.3 | 18.1 ± 0.7 | 88.1 ± 2.0 | 236.7 ± 26.9 | 90.4 ± 9.4 |
| IC_{200,} 2-pass | 0.213 ± 0.002 | 65.1 ± 2.3 | 12.8 ± 0.2 | 45.1 ± 0.6 | 143.2 ± 3.9 | 48.7 ± 1.3 |
| IC_{87,} 1-pass | 0.274 ± 0.006 | 40.0 ± 0.8 | 10.8 ± 0.2 | 30.9 ± 0.2 | 77.7 ± 2.5 | 24.6 ± 0.8 |
| IC_{87,} 3-pass | 0.369 ± 0.001 | 24.5 ± 0.1 | 8.6 ± 0.0 | 21.1 ± 0.1 | 43.4 ± 0.2 | 13.1 ± 0.1 |
| IC_{87,} 5-pass | 0.444 ± 0.006 | 19.2 ± 0.0 | 7.3 ± 0.1 | 17.1 ± 0.1 | 32.8 ± 0.1 | 17.1 ± 0.1 |

^{a}CS, calculated surface which provides an indication of the specific surface area.
^{b}MV, mean diameter of the volume distribution.
^{c}D10, 10% of the volume that is smaller than the size indicated.
^{d}D50, 50% of the volume that is smaller than the size indicated.
^{e}D90, 90% of the volume that is smaller than the size indicated.
^{f}SD, standard deviation which is one measure of the width of the particle size distribution.

### 4.7. Effect of Microfluidization on Bulk Density

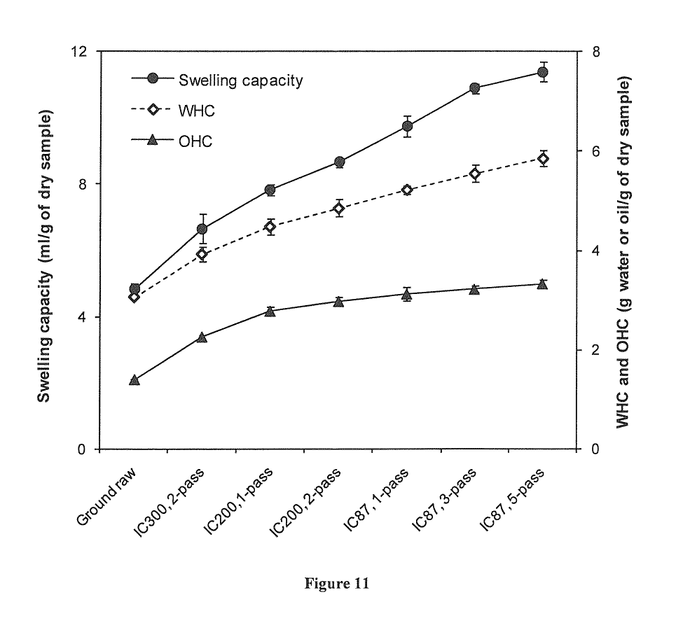

FIG. 11 illustrates bulk density values as a result of microfluidization. As shown, bulk density decreased sharply after being processed through an IC300 for two passes as well as through an IC200 for one pass. Thereafter, it decreased with further processing but at a slower rate.

### 4.8. Effect of Microfluidization on Hydration Properties

Particle size, specific surface area, porosity and microstructure of the bran matrix are all factors influencing bran's hydration properties, including water-holding capacity (WHC) and swelling capacity (SC). The effect of chamber size and the number of microfluidization passes on WHC and SC of corn bran samples is illustrated in FIG. 11. As shown, the ground raw corn bran sample had a WHC of 3.06 g water g⁻¹ of dry sample. The microfluidization process increased the value of WHC and SC. In particular, the first two pass through an IC300 resulted in the largest increase of WHC and SC from 3.06 to 3.92 g water g⁻¹ of dry sample and 4.84 to 6.65 ml g⁻¹ dry sample, respectively. The values of WHC and SC continuously increased with increased microfluidization under the experimental conditions.

Without being bound by theory, microfluidization may lead to the loss of some water-soluble substances present in the bran due to the high pressure and high shear stress experimental conditions; particles suspended in the liquid stream are expanded by the rapid release of pressure at the exit of the interaction chamber. This high degree of expansion may loosen the microstructure of fiber particles and even create micropores or cavities inside the particles. The loosened microstructure, as well as size reduction, exposes a larger surface area and more water binding sites to the surrounding water, resulting in the enhancement of the hydration properties of insoluble fiber ingredients. On the other hand, the considerable compression and shearing forces generated during conventional grinding process can cause the collapse of fiber matrix and pores leading to an opposite effect on hydration properties of fiber materials treated by this method.

### 4.9. Effect of Microfluidization on Oil-Holding Capacity

FIG. 11 depicts changes in oil-holding capacity (OHC) of control (ground raw) and microfluidized corn bran samples under different conditions. As shown, ground raw corn bran had an OHC of 1.39 g oil g⁻¹ dry sample. Two-pass microfluidization through IC300 and IC200 chambers increased OHC from 1.39 to 2.26 and 2.98 g oil g⁻¹ dry sample, but thereafter the effect of microfluidization treatment became less pronounced even though smaller-sized interaction chamber (IC87) was used.

In the present study, the increase in OHC of the microfluidized corn bran could be attributed to the increase in the porosity, exposed surface area of the fiber and consequent enhancement of the physical entrapment of oil by capillary attraction. Microfluidized corn bran, which has an improved oil holding capacity, can be more efficient than its untreated counterpart in binding bile acids and cholesterol, removing them from micelles and thus preventing their intestinal absorption or reabsorption.

### 4.10. Effect of Microfluidization on Cation-Exchange Capacity (CEC)

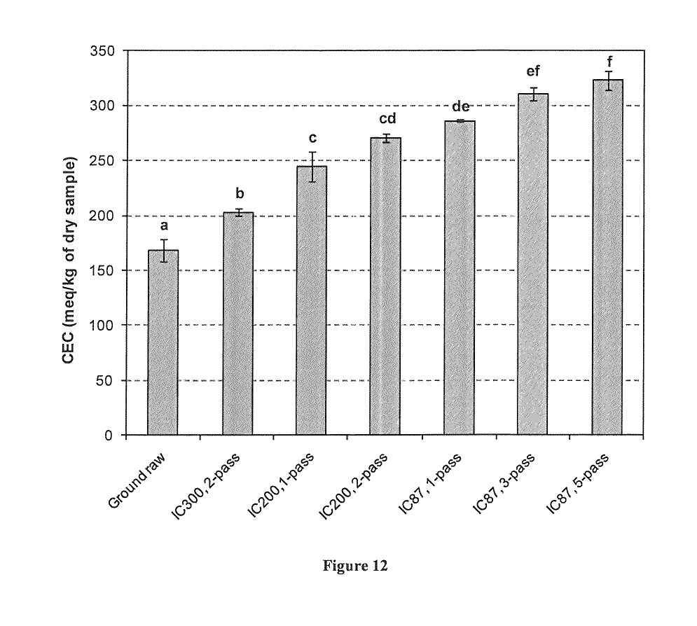

The effect of microfluidization on the CEC of corn bran is shown in FIG. 12. The ground raw corn bran had a CEC value of 168.4 meq kg⁻¹ dry sample. As shown, the CEC increased upon microfluidization in the experimental range. Its value increased from 168.4 to 270.8 meq kg⁻¹ dry sample after two passes through an IC200 and was about 1.9 times of the untreated counterpart after five passes through an IC87.

Microfluidization appeared to be more effective in improving the CEC of corn bran compared to wheat bran; after microfluidization using an IC87 for five passes, the CEC value increased by 91.7% for corn bran while it only reached 23.3% for wheat bran compared to their untreated counterparts. This could be due to the higher amount of trapped uronic acids within the cell wall matrix of corn bran or due to increased exposure of these uronic acid moieties or ion-binding sites after the microfluidization process.

### Example 5

### Materials and Chemicals

Commercial corn bran (Cargill Dry Corn Ingredients, Inc., Paris, Ill., USA) was cleaned, ground and sieved as described above.

### 5.1. Processing of Corn Bran by Microfluidization

Ground, sieved, corn bran was dispersed in distilled water at a ratio of corn bran:water 1:50 (wt/wt). The suspension was then processed at room temperature by an M-110P Microfluidizer Processor (Microfluidics, Newton, Mass., USA) through three sizes of interaction chambers having diameters of 300 μm (IC300), 200 μm (IC200), and 87 μm (IC87) at 69, 159, and 172 MPa for the IC300, IC200 and IC87, respectively. Interaction chambers used in this study had a “Z” shape. Bran suspensions were first processed twice through the IC300 and then through the IC200 for 1 or 2 passes. Samples that were additionally processed with IC87 were pre-processed through IC300 and IC200 (two passes for each interaction chamber).

The processed bran samples were collected by centrifugation and freeze-dried. The moisture content of the freeze-dried samples ranged from 3.5 to 5.3%. Dry samples were sealed in air-tight glass containers and stored at −30° C. for analysis. All experiments were performed in duplicate.

### 5.2. Investigation of Microfluidized Sample

The analysis of the phenolic compounds, the measurement of reducing power and the measurement of ferrous ion-chelating ability, as well as the determination of ABTS and DPPH radical scavenging activities of the microfluidized bran sample followed the procedure described above

### 5.3. Analysis of Phenolic Acids by HPLC-ECD

An HPLC-ECD system (ESA, Chelmsford, Mass., USA) consisting of an ESA model 584 HPLC pump, an ESA model 542 autosampler, and an ESA organizer, and an ESA electrochemical detector (ECD) coupled with two ESA model 6210 four sensor cells was used. Chromatographic analysis was performed on a Gemini C18 column (150 mm×4.6 mm i.d., 5 μm, Phenomenex, Torrance, Calif., USA). The mobile phase consisted of solvent A (50 mM sodium phosphate monobasic monohydrate buffer containing 10% methanol, pH 2.47) and solvent B (50 mM sodium phosphate monobasic monohydrate buffer containing 40% methanol and 20% ACN, pH 2.47). The gradient elution had the following profile: 5% B from 0 to 10 min at a flow rate of 0.5 mL/min; 5-20% B from 10 to 15 min with a increasing flow rate ranged from 0.5 mL/min to 0.8 mL/min; 20-100% from 15 to 48 min at a flow rate of 0.8 mL/min; 100% B from 48 to 53 min; and 5% B from 53.2 to 60 min. The cells were then cleaned at a potential of 900 mV for 1 min. The injection volume of the sample was 10 μL. The eluent was monitored by the Coulochem electrode array system (CEAS) with potential settings at 200 mV, 300 mV, 470 mV, 520 mV, 600 mV, 670 mV, and 720 mV. Phenolic acids present in the samples were identified by comparing the chromatographic retention times with those of authentic commercial standards. Phenolic acid standards including ferulic acid, p-coumaric acid, syringic acid, p-hydroxybenzoic acid, caffeic acid, and sinapic acid (95% and higher purity) were purchased from Sigma-Aldrich (St. Louis, Mo., USA).

### 5.4. Statistical Analysis

The microfluidization experiment was replicated two times (n=2) and analyses were performed independently three times (a=3). Analysis of variance (ANOVA) was applied to the data using the Number Cruncher Statistical Software, NCSS 2000 (NCSS, Kaysville, Utah, USA). Significant differences were determined by one way ANOVA and Tukey-Kramer Multiple-Comparison Test was used to determine the statistical difference between sample groups. Significance of differences was defined at the 5% level (p<0.05).

### 5.5. Effect of Microfluidization on Surface-Reactive Phenolic Compounds

Table 5-1 shows the content of surface-reactive phenolic compounds of corn bran as affected by the microfluidization treatment. The initial value of the ground raw corn bran was 4.6 mg GAE/g d.w. Additional microfluidization resulted in a gradual increase in surface-reactive phenolic content with the final value reaching 17.5 mg GAE/g d.w. after five-pass microfluidization using an IC87. Increased accessibility of bound phenolic compounds may have resulted from particle size reduction and loosening of the fiber matrix induced by microfluidization.

TABLE 5-1
Effect of interaction chamber size and number of
passes on surface-reactive phenolic content and antioxidant
properties of microfluidized corn bran

| | | | | | Ferrous ion |
|---|---|---|---|---|---|
| | | | | | chelating |
| | | | | Reducing | ability |
| | | TEAC | DPPH | power | (μmol |
| | SR-PC | value | (μmol | (AAE, | EDTA |
| Sample | (GAE, mg/ | (μmol/g | TE/g | mg/g | equiv./ |
| group | g d.w.)⁽¹⁾ | d.w.)⁽²⁾ | d.w.)⁽³⁾ | d.w.)⁽⁴⁾ | g d.w.) |
| Ground | 4.6 ± 0.2^{a} | 34.0 ± 0.9^{a} | 22.6 ± 1.2^{a} | 9.4 ± 0.6^{a} | 14.1 ± 0.3^{d} |
| raw | | | | | |
| IC₃₀₀, | 6.5 ± 0.1^{b} | 41.1 ± 0.5^{a} | 29.1 ± 1.5^{b} | 12.6 ± 0.4^{b} | 9.2 ± 0.3^{c} |
| 2-pass | | | | | |
| IC₂₀₀, | 11.2 ± 0.4^{c} | 52.5 ± 2.2^{b} | 41.1 ± 1.5^{c} | 17.4 ± 0.5^{c} | 6.8 ± 0.6^{b} |
| 1-pass | | | | | |
| IC₂₀₀, | 12.8 ± 0.7^{d} | 61.4 ± 1.9^{c} | 46.4 ± 1.3^{c} | 18.8 ± 0.4^{cd} | 5.7 ± 0.3^{ab} |
| 2-pass | | | | | |
| IC₈₇, | 14.9 ± 0.2^{e} | 73.6 ± 2.6^{d} | 55.4 ± 1.5^{d} | 20.7 ± 0.1^{d} | 4.9 ± 0.3^{a} |
| 1-pass | | | | | |
| IC₈₇, | 16.4 ± 0.2^{ef} | 85.1 ± 1.6^{e} | 62.9 ± 1.0^{e} | 23.0 ± 0.7^{e} | 5.0 ± 0.4^{a} |
| 3-pass | | | | | |
| IC₈₇, | 17.5 ± 0.5^{f} | 93.5 ± 3.4^{f} | 67.6 ± 1.9^{e} | 25.1 ± 0.9^{e} | 4.3 ± 0.2^{a} |
| 5-pass | | | | | |

Each value is expressed as means ± S.D. (n = 2, a = 3)
Values in same column followed by different superscript letters are significantly different (P < 0.05).
⁽¹⁾SR-PC: surface-reactive phenolic content; GAE: gallic acid equivalents.
⁽²⁾TEAC: Trolox equivalent antioxidant capacity.
⁽³⁾TE: Trolox equivalent.
⁽⁴⁾AAE: ascorbic acid equivalent.

### 5.6. Effect of Microfluidization on Antioxidant Activity of Corn Bran

Antioxidant activity of the surface-exposed antioxidant functional groups of insoluble bound phenolics was evaluated by four in vitro assays based upon different reaction mechanisms, including DPPH and ABTS cation radical scavenging capacity, reducing power and ferrous ion-chelating ability.

### 5.6.1. ABTS and DPPH Radical Scavenging Capacity

The effect of microfluidization on the ABTS cation radical scavenging activity of corn bran is illustrated in Table 5-1. As shown in the table, the TEAC value increased from 34.0 to 41.1, 61.4, and 93.5 μmol trolox equivalent/g d.w. after 2 passes through an IC300, 2 passes through an IC200, and 5 passes through an IC87, respectively. There were strong positive correlations between the content of surface-reactive phenolics and ABTS cation radical scavenging capacity based on the Pearson correlation analysis (r=0.98). While reducing overall particle size, microfluidization expands the bran material due to the rapid release of high pressure at the end of the process and increases their porosity. These combined effects increased the exposure of antioxidant functional groups of the bound phenolic compounds, as reflected by the increase in antioxidant activity.

The effect of microfluidization on DPPH radical scavenging activity showed a similar pattern as that for the ABTS assay (Table 5-1). However, the TEAC values of microfluidized corn bran determined by the ABTS assay were generally higher than those determined by DPPH assay, probably because phenolic compounds with different chemical structures may exhibit varying degrees of scavenging capacity on different types of free radicals.

### 5.6.2.Reducing Power

As shown in Table 5-1, the reducing power of corn bran increased with microfluidization. Reducing power assay is generally used to evaluate the ability of phenolic antioxidants to break the free radical chain reactions via hydrogen atom donation or preventing peroxide formation through reaction with certain precursors of peroxide. It is a good indicator of intrinsic antioxidant activity of cereal phenolics because it is generally highly correlated with antioxidant activities of a variety of grains and grain extracts.

### 5.6.3. Ferrous Ion-Chelating Activity

As shown in Table 5-1, the ferrous ion-chelating activity of corn bran decreased with microfluidization although the treatment increased the contents of exposed phenolic acids as shown above. This trend suggested that (a) the phenolic acids, such as ferulic acid, are not good metal chelators, and (b) microfluidization might cause the loss or degradation of some constituents with metal-chelating ability or reduction of the number of metal ion-binding sites in the fiber matrix due to the microstructural changes.

### 5.7. Effect of Microfluidization on Phenolic Contents and Antioxidant Activities of Solvent, Alkali and Acid Extracts

As shown in Table 5-2, the solvent extractable phenolic content decreased with microfluidization, probably because a portion of the solvent extractable phenolics were dispersed in the water phase and lost under the action of high pressure and high shearing stresses during the microfluidization process.

TABLE 5-2
Contents of solvent extractable, alkaline and acid hydrolysable
phenolic acids in ground raw and microfulidized corn bran ⁽¹⁾

| Sample | Solvent | Aklaline | Acid | |
|---|---|---|---|---|
| group | Extractable | hydrolysable | hydrolysable | Final residue |
| Ground | 3.35 ± 0.03^{e} | 17.57 ± 0.51^{a} | 3.67 ± 0.15^{a} | 10.94 ± 0.31^{a} |
| raw | | | | |
| IC₃₀₀, | 2.93 ± 0.08^{d} | 19.90 ± 0.34^{ab} | 3.90 ± 0.12^{ab} | 11.84 ± 0.69^{ab} |
| 2-pass | | | | |
| IC₂₀₀, | 2.83 ± 0.06^{cd} | 22.19 ± 1.10^{bc} | 4.22 ± 0.07^{bc} | 12.39 ± 0.66^{abc} |
| 1-pass | | | | |
| IC₂₀₀, | 2.74 ± 0.04^{bcd} | 22.60 ± 1.33^{bc} | 4.33 ± 0.08^{cd} | 13.22 ± 0.45^{bc} |
| 2-pass | | | | |
| IC₈₇, | 2.62 ± 0.07^{abc} | 23.47 ± 0.86^{c} | 4.47 ± 0.07^{cde} | 13.87 ± 0.32^{bc} |
| 1-pass | | | | |
| IC₈₇, | 2.53 ± 0.05^{ab} | 24.57 ± 0.55^{c} | 4.64 ± 0.05^{de} | 14.24 ± 0.48^{c} |
| 3-pass | | | | |
| IC₈₇, | 2.46 ± 0.03^{a} | 25.35 ± 0.34^{c} | 4.82 ± 0.13^{e} | 14.44 ± 0.66^{c} |
| 5-pass | | | | |

Each value is expressed as means ± S.D. (n = 2, a = 3) .
Values in same column followed by different superscript letters are significantly different (P < 0.05).
⁽¹⁾ For solvent extractable, alkaline and acid hydrolysable phenolic fractions, the results were expressed as mg of gallic acid equivalents (GAE) per gram of dry weight (d.w.) of corn bran; for the final residue after the alkaline and acid hyrolysis, the result was expressed as mg GAE per gram of d.w. of residue.

Bound phenolic compounds are unextractable by aqueous-organic solvents without alkali or acid hydrolysis. As shown in Table 5-2, both the alkaline and acid hydrolysable phenolic contents increased with microfluidization, likely because the complex bran structure opened and exposed more bound phenolic compounds for the hydrolysis reaction. The residues of corn bran after alkali and acid hydrolysis still contained a fairly high content of surface-reactive phenolic compounds, which increased with extended microfluidization.

The antioxidant capacity of each of the above-mentioned fractions of phenolic compounds was analyzed by the ABTS assay (Table 5-3). As expected, the changes of antioxidant capacity with microfluidization followed a similar trend to that for the measured phenolic content. In accordance with their high phenolic contents, the residues of corn bran also exhibited strong ABTS radical scavenging activity.

TABLE 5-3
Trolox equivalent antioxidant capacity (TEAC) of
solvent extractable, alkaline and acid hydrolysable phenolic
acid fractions of different corn bran samples⁽¹⁾

| Sam- | Solvent | Alkaline | Acid | |
|---|---|---|---|---|
| ple | | | | |
| group | Extractable | hydrolysable | hydrolysable | Final residue |
| Ground | 22.99 ± 0.10^{d} | 174.05 ± 3.03^{a} | 21.75 ± 0.48^{a} | 61.73 ± 0.74^{a} |
| raw | | | | |
| IC₃₀₀, | 21.63 ± 0.57^{cd} | 182.59 ± 3.79^{ab} | 25.24 ± 1.29^{ab} | 66.20 ± 2.86^{ab} |
| 2-pass | | | | |
| IC₂₀₀, | 20.84 ± 0.92^{cd} | 195.92 ± 7.25^{abc} | 27.03 ± 1.14^{bc} | 71.52 ± 2.29^{bc} |
| 1-pass | | | | |
| IC₂₀₀, | 19.74 ± 0.85^{bc} | 204.81 ± 1.70^{bcd} | 28.28 ± 0.60^{bcd} | 75.40 ± 1.27^{cd} |
| 2-pass | | | | |
| IC₈₇, | 18.89 ± 0.40^{abc} | 215.04 ± 7.88^{cde} | 30.55 ± 0.73^{cde} | 78.84 ± |
| 1-pass | | | | 2.01^{cde} |
| IC₈₇, | 17.23 ± 1.14^{ab} | 226.74 ± 9.67^{de} | 32.08 ± 0.65^{de} | 81.61 ± 2.83^{de} |
| 3-pass | | | | |
| IC₈₇, | 16.23 ± 0.88^{a} | 236.79 ± 7.61^{e} | 33.90 ± 1.45^{e} | 84.60 ± 2.28^{e} |
| 5-pass | | | | |

Each value is expressed as means ± S.D. (n = 2, a = 3) .
Values in the same column followed by different superscript letters are significantly different (P < 0.05).
⁽¹⁾ For solvent extractable, alkaline and acid hydrolysable phenolic fractions, the results were expressed as μmol Trolox equivalents per gram of dry weight (d.w.) of corn bran; for the final residue after the alkaline and acid hydrolysis, the result was expressed as μmol Trolox equivalents per gram of d.w. of residue.

### 5.8. Effect of Microfluidization on Phenolic Profiles of Solvent, Alkali and Acid Extracts

The typical HPLC chromatographic profiles of phenolic compounds in solvent, alkali and acid extracts from native and microfluidized corn bran through an IC87 showed the presence of p-coumaric acid (major one), syringic acid, a ferulic acid; p-hydroxybenzoic acid and sinapic acid were also detected but at lower levels. Several other peaks remained unidentified because they did not match the reference standards. Microfluidization led to loss in all the identified phenolic acids in the solvent extracts, consistent with the TPC result.

The profile of phenolic acids released after alkaline hydrolysis of both untreated and microfluidized corn bran showed that ferulic acid was the predominant component. The second most abundant was p-coumaric acid, at a level much lower than ferulic acid. Syringic acid and p-hydroxybenzoic acid were identified in the alkaline fraction in even lower amounts. Generally, microfluidization through an 87 μm interaction chamber for 5 passes enhanced the liberation of the bound phenolic acids, which increased by 45.1% and 51.1% for ferulic acid and p-coumaric acid, respectively.

Ferulic acid was also the dominant phenolic acid liberated after subsequent acid hydrolysis with 6 M HCl at 95° C., followed by lesser quantities of syringic acid and p-coumaric acid as well as other unidentified phenolic acids. In contrast to alkaline hydrolysis, the release of bound phenolic acids during acid hydrolysis was only slightly affected by the microfluidization treatment, the percentage increase being only 6.3% and 3.1% for ferulic acid and p-coumaric acid, respectively. On the other hand, syringic acid content showed a slight decrease compared with that of the untreated bran.

Particle size distribution was measured using a laser particle size analyzer. The physicochemical properties including bulk density, hydration properties, oil-holding capacity and cation-exchange capacity were also measured (Table 5-4). The microfluidized particles showed a decrease in particle size and bulk density, an increase in specific surface area, hydration properties, and oil holding capacity, and slight increase in cation-exchange capacity.

TABLE 5-4
Effects of the microfluidization process on mean particle size and
physicochemical propcrties of corn bran.

| | | | | SC^{d} | WHC^{e} | OHC^{f} | CEC^{g} |
|---|---|---|---|---|---|---|---|
| Bran | MV^{a} | CS^{b} | BD^{c} | (ml/g | (g H₂O/ | (g oil/ | (meq/ |
| sample | (μm) | (m²/cm³) | (g/ml) | d.w.) | d.w.) | d.w.) | kg d.w) |
| Ground | 417.1 ± | 0.024 ± | 0.42 ± | 4.8 ± | 3.1 ± | 1.4 ± | 168.4 ± |
| raw | 1.6 | 0.001 | 0.03 | 0.2 | 0.0 | 0.0 | 10.1 |
| IC₃₀₀, | 292.1 ± | 0.065 ± | 0.35 ± | 6.7 ± | 3.9 ± | 2.3 ± | 203.2 ± |
| 2 passes | 8.6 | 0.002 | 0.01 | 0.4 | 0.1 | 0.0 | 3.7 |
| IC₂₀₀, | 112.2 ± | 0.145 ± | 0.29 ± | 7.8 ± | 4.5 ± | 2.8 ± | 244.6 ± |
| 1 pass | 8.3 | 0.006 | 0.01 | 0.2 | 0.2 | 0.1 | 13.5 |
| IC₂₀₀, | 65.1 ± | 0.213 ± | 0.27 ± | 8.7 ± | 4.9 ± | 3.0 ± | 270.8 ± |
| 2 passes | 2.3 | 0.002 | 0.01 | 0.1 | 0.2 | 0.1 | 3.7 |
| IC₈₇, | 40.0 ± | 0.274 ± | 0.25 ± | 9.7 ± | 5.2 ± | 3.1 ± | 285.9 ± |
| 1 pass | 0.8 | 0.006 | 0.01 | 0.3 | 0.1 | 0.1 | 1.2 |
| IC₈₇, | 24.5 ± | 0.369 ± | 0.24 ± | 10.9 ± | 5.5 ± | 3.2 ± | 310.2 ± |
| 3 passes | 0.1 | 0.001 | 0.01 | 0.1 | 0.2 | 0.1 | 6.1 |
| IC₈₇, | 19.2 ± | 0.444 ± | 0.23 ± | 11.4 ± | 5.9 ± | 3.3 ± | 322.8 ± |
| 5 passes | 0.0 | 0.006 | 0.01 | 0.3 | 0.2 | 0.1 | 8.6 |

^{a}MV, mean diameter of the volume distribution.
^{b}CS, calculated surface which provides an indication of the specific surface area.
^{c}BD, bulk density.
^{d}SC, swelling capacity.
^{e}WHC, water-holding, capacity,
^{f}OHC, oil-holding capacity.
^{g}CEC, cation-exchange capacity.

After two pass microfluidization using an IC₂₀₀, the major fraction of the treated corn bran was in the form of fine particles, accompanied by a small amount of recognizable cell wall remnants, as determined by confocal laser microscopy. When corn bran was further processed by an IC₈₇, the particle size kept decreased with an increased number of passes; the disruption of the pericarp and aleurone cells was more complete and the dissociation of different bran tissues was more pronounced. The amounts of fine particulates increased as the extent of microfluidization treatment increased.

These data indicate that microfluidization process provides an effective way to modify the physicochemical properties of brans and improve their nutritional values and compatibility with food processing and food matrices.

### INCORPORATION BY REFERENCE

The patents and publications listed herein describe the general skill in the art. All publications, patents, and patent applications mentioned in this specification are herein incorporated by reference to the same extent as if each individual publication, patent, or patent application was specifically and individually indicated to be incorporated by reference. In the case of any conflict between a cited reference and this specification, the specification shall control.

In describing embodiments of the present application, specific terminology is employed for the sake of clarity. However, the presently disclosed subject matter is not intended to be limited to the specific terminology so selected. Nothing in this specification should be considered as limiting the scope of the presently disclosed subject matter. All examples presented are representative and non-limiting. The above-described embodiments can be modified or varied, without departing from the presently disclosed subject matter, as appreciated by those skilled in the art in light of the above teachings. It is therefore to be understood that, within the scope of the claims and their equivalents, the presently disclosed subject matter can be practiced otherwise than as specifically described.

What is claimed:

1. A foodstuff comprising microfluidized bran, wherein said bran comprises oat bran, corn bran, rice bran, rye bran, barley bran and/or millet bran.

2. The foodstuff of claim 1 wherein said bran comprises oat bran and/or corn bran.

3. The foodstuff of claim 1 wherein said foodstuff is a soup, salad dressing, dip, sauce, baked good, extruded cereal or beverage.

4. The foodstuff of claim 2 wherein said bran is corn bran.

5. The foodstuff of claim 4 wherein said foodstuff is a baked good or extruded cereal.

6. The foodstuff of claim 2 wherein said bran is oat bran.

7. The foodstuff of claim 6 wherein said foodstuff is a baked good or a beverage.

8. A method for the manufacture of a foodstuff comprising adding microfluidized bran to said foodstuff, wherein said bran comprises oat bran, corn bran, rice bran, rye bran, barley bran and/or millet bran.

9. The method of claim 8 wherein said bran is corn bran.

10. The method of claim 8 wherein said bran is oat bran.

11. The method of claim 8, wherein said foodstuff is a soup, salad dressing, dip, sauce, baked good, extruded cereal or beverage.

12. The method of claim 11 wherein said foodstuff is a baked good or a beverage.

13. A foodstuff comprising microfluidized corn bran optionally in combination with microfluidized oat bran, wherein said microfluidized corn bran has:
a. a specific surface area of at least about 0.15 m²/cm³; and
b. a median diameter of volume distribution of at most about 100 μm.

14. The baked good of claim 13, wherein said baked good is bread having at least about 10 g dietary fiber/100 g bread.

15. A flour mixture comprising between about 5% and about 35% by mass microfluidized bran.

16. The flour mixture of claim 15 wherein said bran comprises oat bran, corn bran, rice bran, rye bran, barley bran and/or millet bran.

17. The flour mixture of claim 15 wherein at least about 15% of the flour mixture by mass comprises microfluidized corn bran, microfluidized oat bran, or a combination thereof.

18. The flour mixture of claim 15 wherein microfluidized corn bran comprises no more than about 15% of the flour mixture by mass and microfluidized oat bran comprises no more than about 15% of the flour mixture by mass.

19. The flour mixture of claim 15 wherein between about 10% and about 30% of the flour mixture by mass comprises microfluidized corn bran, microfluidized at bran, or a combination thereof.

20. The flour mixture of claim 15 wherein the microfluidized bran consists essentially of microfluidized corn bran and/or microfluidized oat bran.

21. A foodstuff prepared from the flour mixture of claim 15.

22. A foodstuff prepared from the flour mixture of claim 19.

23. A beverage containing microfluidized bran, wherein said bran comprises oat bran, corn bran, rice bran, rye bran, barley bran and/or millet bran.
